(19) United States
(12) Patent Application Publication
(10) Pub. No.: US 2021/0200383 A1
(43) Pub. Date: Jul. 1, 2021

(54) ETCHING SOLUTION, TOUCH PANEL AND MANUFACTURING METHOD THEREOF

(71) Applicant: Cambrios Film Solutions Corporation, Tortola (VG)

(72) Inventors: Chung-Chin Hsiao, Hsinchu County (TW); Siou-Cheng Lien, Miaoli County (TW); Chi-Fan Hsiao, Taoyuan City (TW); Chia-Yang Tsai, New Taipei City (TW); Yi-Wen Chiu, Taoyuan City (TW)

(21) Appl. No.: 17/126,179

(22) Filed: Dec. 18, 2020

(30) Foreign Application Priority Data
Dec. 31, 2019 (CN) 201911416476.2
Sep. 9, 2020 (CN) 202010943906.2

(51) Int. Cl. G06F 3/044; C23C 18/40; C23C 18/16

(52) U.S. Cl. CPC G06F 3/0446; G06F 3/0445; G06F 2203/04103; C23C 18/40; C23C 18/1689; G06F 3/0443

(57) ABSTRACT

The present disclosure discloses an etching solution, a touch panel, and a manufacturing method thereof. The manufacturing method of the touch panel includes the following operations. A substrate is provided, in which the substrate has a visual area and a peripheral area. A metal layer and a metal nanowire layer are disposed, in which a first portion of the metal nanowire layer is disposed in the visual area, and a second portion of the metal nanowire layer and the metal layer are disposed in the peripheral area. A patterning step is performed. The patterning step includes simultaneously forming multiple peripheral wires and the second portion of the metal nanowire layer by using the etching solution for etching the metal layer and the metal nanowire layer.

### CROSS-REFERENCE TO RELATED APPLICATION

This application claims priority to China Application Serial Number 201911416476.2, filed Dec. 31, 2019, and China Application Serial Number 202010943906.2, filed on Sep. 9, 2020. China Application Serial Number 201911416476.2 and China Application Serial Number 202010943906.2 are incorporated by reference.

### BACKGROUND

### Field of Disclosure

The present disclosure relates to an etching solution, a touch panel, and a manufacturing method thereof.

### Description of Related Art

In recent years, transparent conductors have allowed light to pass through and at the same time provide appropriate conductivity; thus, transparent conductors are often used in many display or touch-related devices. Generally, transparent conductors can be various metal oxides, such as indium tin oxide (ITO), indium zinc oxide (IZO), cadmium tin oxide (CTO), or aluminum-doped zinc oxide (AZO). However, these metal oxide films cannot meet the requirement of the flexibility of display devices. Therefore, a variety of flexible transparent conductors have been developed today, such as transparent conductors made of nanowires.

However, there are still many problems that need to be solved in the nanowire process technology. For example, if nanowires are used to make touch electrodes, the alignment bit error area needs to be reserved for aligning the nanowires and the wires in the peripheral area. The alignment bit error area causes the size of the wires in the peripheral area to be unable to be shrunk, resulting in a larger width of the peripheral area. Especially, in a roll-to-roll process, the deformation of the substrate causes the size of the alignment bit error area to be enlarged (such as to 150 μm), so that the minimum width of the peripheral area is 2.5 mm. Therefore, the current process cannot meet the narrow bezel requirement of displays. Furthermore, the choice of an etching solution is also a problem.

### SUMMARY

In some embodiments of the present disclosure, a patterning of a metal nanowires layer or a metal layer is directly performed through an etching solution, so as to achieve the purpose of simplifying the manufacturing process and controlling the manufacturing cost. The etching solution can provide good etching characteristics.

In some embodiments of the present disclosure, an one-time etching step of the metal nanowires layer and the metal layer is used to achieve the effect that there is no need to reserve the alignment bit error area during alignment, so as to form a peripheral wire with a smaller width, thereby satisfying the requirement of the narrow bezel.

In some embodiments of the present disclosure, a different-steps etching of the metal nanowires layer and the metal layer is used to achieve the effect that there is no need to reserve the alignment bit error area during alignment, so as to form a peripheral wire with a smaller width, thereby satisfying the requirement of the narrow bezel. At the same time, due to the etching solution only selectively etching the metal nanowires layer but not the metal layer, the problem of incomplete etching of the metal nanowires layer in the peripheral area and the visual area can be avoided, or the problem of side etching of the metal layer in the peripheral area can be avoided.

According to some embodiments of the present disclosure, a manufacturing method of a touch panel includes the following steps. A substrate is provided, in which the substrate has a visual area and a peripheral area. A metal layer and a metal nanowires layer are disposed, in which a first portion of the metal nanowires layer is located in the visual area, and a second portion of the metal nanowires layer and the metal layer are located in the peripheral area. A patterning step is performed, in which the patterning step includes forming the metal layer into multiple peripheral wires and simultaneously forming the second portion of the metal nanowires layer into multiple etching layers by using an etching solution for etching the metal layer and the metal nanowire layer. The etching solution includes 0.2-40 wt % of hydrogen peroxide, 0.1-20 wt % of an acid, 0.1-10 wt % of a metal corrosion inhibitor, 0.1-10 wt % of a stabilizer, and a balance of a solvent.

In some embodiments of the present disclosure, the patterning step further includes forming the first portion of the metal nanowires layer into a touch sensing electrode by using the etching solution, in which the touch sensing electrode is disposed on the substrate in the visual area, and the touch sensing electrode is electrically connected to the multiple peripheral wires.

In some embodiments of the present disclosure, the metal corrosion inhibitor includes a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

In some embodiments of the present disclosure, the stabilizer includes ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

In some embodiments of the present disclosure, the disposing the metal layer and the metal nanowires layer includes the following steps. The metal layer is disposed in the peripheral area. Subsequently, the metal nanowires layer is disposed in the visual area and the peripheral area, in which the first portion is located in the visual area and formed on the substrate, and the second portion is located in the peripheral area and formed on the metal layer.

In some embodiments of the present disclosure, the disposing the metal layer in the peripheral area includes the following steps. The metal layer is formed in the peripheral area and the visual area. The metal layer located in the visual area is removed.

In some embodiments of the present disclosure, a composition of the etching solution includes 1.0-10.0 wt % of hydrogen peroxide, 1.0-5.0 wt % of the acid, 2.0-7.0 wt % of the metal corrosion inhibitor, 3.0-8.0 wt % of the stabilizer, and a balance of a solvent.

In some embodiments of the present disclosure, the patterning step further includes forming the metal layer into multiple marks by using the etching solution, in which the multiple etching layers include multiple first coverings and multiple second coverings, each of the multiple first coverings is correspondingly disposed on the multiple peripheral wires, and each of the multiple second coverings is correspondingly disposed on the multiple marks.

In some embodiments of the present disclosure, the disposing the metal layer and the metal nanowires layer includes the following steps. The metal nanowires layer is disposed in the visual area and the peripheral area. Subsequently, the metal layer is disposed in the peripheral area, in which the metal layer is located on the second portion.

In some embodiments of the present disclosure, the disposing the metal layer and the metal nanowires layer includes the following steps. The metal layer is disposed in the peripheral area. Subsequently, the metal nanowires layer is disposed in the visual area and the peripheral area, in which the first portion is located in the visual area and formed on the substrate, and the second portion is located in the peripheral area and formed on the metal layer.

In some embodiments of the present disclosure, a composition of the etching solution includes 1.0-5.0 wt % of hydrogen peroxide, 0.1-0.6 wt % of the acid, 2.0-7.0 wt % of the metal corrosion inhibitor, 3.0-8.0 wt % of the stabilizer, and a balance of a solvent.

In some embodiments of the present disclosure, the patterning step further includes forming the metal layer into multiple marks by using the etching solution, in which the multiple etching layers include multiple first interlayers and multiple second interlayers, each of the multiple first interlayers is correspondingly disposed between the multiple peripheral wires and the substrate, and each of the multiple second interlayers is correspondingly disposed between the multiple marks and the substrate.

In some embodiments of the present disclosure, the manufacturing further includes disposing a film layer.

In some embodiments of the present disclosure, the manufacturing method is performed on one side or both sides of the substrate.

In some embodiments of the present disclosure, a touch panel is provided.

According to some embodiments of the present disclosure, an etching solution used for performing a patterning step includes 0.2-40 wt % of hydrogen peroxide, 0.1-20 wt % of an acid, 0.1-10 wt % of a metal corrosion inhibitor, 0.1-10 wt % of a stabilizer, and a balance of a solvent.

In some embodiments of the present disclosure, the acid includes an organic acid, an inorganic acid, or combinations thereof.

In some embodiments of the present disclosure, the organic acid includes a carboxylic acid, a dicarboxylic acid, a tricarboxylic acid, an alkyl carboxylic acid, an acetic acid, an oxalic acid, a benzenehexacarboxylic acid, a formic acid, a chloroacetic acid, a benzoic acid, a trifluoroacetic acid, a propionic acid, a butyric acid, or combinations thereof.

In some embodiments of the present disclosure, the inorganic acid includes a phosphoric acid, a nitric acid, a hydrochloric acid, or combinations thereof.

In some embodiments of the present disclosure, the metal corrosion inhibitor includes a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

In some embodiments of the present disclosure, the stabilizer includes ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

According to some embodiments of the present disclosure, an etching solution used for performing a patterning step includes 0.01-50 wt % of hydrogen peroxide, 0.1-10 wt % of a metal corrosion inhibitor, 0.1-10 wt % of a stabilizer, and a balance of a solvent.

According to some embodiments of the present disclosure, a manufacturing method of a touch panel includes the following steps. A substrate is provided, in which the substrate has a visual area and a peripheral area. A metal layer and a metal nanowires layer are disposed, in which a first portion of the metal nanowires layer is located in visual area, and a second portion of the metal nanowires layer and the metal layer are located in the peripheral area. A patterning step is performed, in which the patterning step includes etching the metal nanowires layer by using an etching solution and etching the metal layer by using a second etching solution, to form the metal layer into multiple peripheral wires and simultaneously form the second portion of the metal nanowires layer into multiple etching layers. The etching solution includes 0.01-50 wt % of hydrogen peroxide, 0.1-10 wt % of a metal corrosion inhibitor, 0.1-10 wt % of a stabilizer, and a balance of a solvent.

### BRIEF DESCRIPTION OF THE DRAWINGS

FIG. 1A to FIG. 10 are schematic views of steps of a manufacturing method of a touch panel according to some embodiments of the present disclosure.

FIG. 2 is a schematic top view of a touch panel according to some embodiments of the present disclosure.

FIG. 2A is a cross-sectional view taken along the line A-A in FIG. 2.

FIG. 2B is a cross-sectional view taken along the line B-B in FIG. 2.

FIG. 3 is a schematic top view of a touch panel and a flexible printed circuit board after assembly according to some embodiments of the present disclosure.

FIG. 4 is a schematic view of a touch panel according to another embodiment of the present disclosure.

FIG. 5 is a schematic top view of a touch panel according to another embodiment of the present disclosure.

FIG. 5A is a cross-sectional view taken along the line A-A in FIG. 5.

FIG. 6A to FIG. 6C are schematic views of steps of a manufacturing method of a touch panel according to some embodiments of the present disclosure.

FIG. 7 is a schematic top view of a touch panel according to another embodiment of the present disclosure.

FIG. 7A is a cross-sectional view taken along the line A-A in FIG. 7.

FIG. 7B is a cross-sectional view taken along the line B-B in FIG. 7.

FIG. 8 is a schematic view of a touch panel according to another embodiment of the present disclosure.

FIG. 9 is a schematic top view of a touch panel according to another embodiment of the present disclosure.

FIG. 9A is a cross-sectional view taken along the line A-A in FIG. 9.

FIG. 10 is a schematic top view of a touch panel according to another embodiment of the present disclosure.

FIG. 11 is a schematic top view of a touch panel according to another embodiment of the present disclosure.

FIG. 12 is a scanning electron microscope (SEM) image after an etching step according to the present disclosure.

FIG. 13A to FIG. 13E are schematic views of steps of another manufacturing method of a touch panel according to some embodiments of the present disclosure.

### DETAILED DESCRIPTION

Hereinafter, several embodiments of the present disclosure will be disclosed with the accompanying drawings. Many practical details will be described in the following description for a clear description. However, it should be understood that these practical details should not be used to limit the present disclosure. That is, in some embodiments of the present disclosure, these practical details are unnecessary. In addition, in order to simplify the drawings, some conventional structures and elements will be shown in the drawings in a simple schematic manner.

With regard to “about”, “around”, or “approximately” used herein, the numerical error or range of the error is generally within 20%, preferably within 10%, or more preferably within 5%. If it is not stated herein, the mentioned values are regarded as approximate values; that is, there are errors or ranges as indicated by “about”, “around” or “approximately”.

The present disclosure provides an etching solution. A composition of the etching solution includes about 0.2-40 wt % of hydrogen peroxide, about 0.1-20 wt % of an acid, about 0.1-10 wt % of a metal corrosion inhibitor, about 0.1-10 wt % of a stabilizer, and a balance of a solvent. Through the above etching solution, a first covering C1 is disposed on a top surface 124 of a peripheral wire 120 by a one-time etching step, so that the first covering C1 and the peripheral wire 120 can be formed in a predetermined position without alignment of the upper material and the lower material. Therefore, it is possible to reduce or avoid the need for alignment bit error area in the manufacturing process, and so the width of a peripheral area PA can be reduced, thereby achieving the narrow bezel requirement of displays. The etching solution of the present disclosure further includes about 20 wt % to 99.9 wt % of the solvent.

An etching solution is also provided in the present disclosure. A composition of the etching solution includes 0.01-50 wt % of hydrogen peroxide, 0.1-10 wt % of a metal corrosion inhibitor, 0.1-10 wt % of stabilizer, and a balance of a solvent. The above etching solution only selectively etches a metal nanowires layer NWL but not a metal layer ML. A first covering C1 is disposed on a top surface 124 of a peripheral wire 120 by using a different-steps etching, so that the first covering C1 and the peripheral wire 120 can be formed in a predetermined position without the alignment of the upper material and the lower material. Therefore, it is possible to reduce or avoid the need for alignment bit error area in the manufacturing process, and so the width of the peripheral area PA can be reduced, thereby achieving the narrow bezel requirement of displays. The etching solution of the present disclosure further includes about 30 wt % to 99.9 wt % of a solvent.

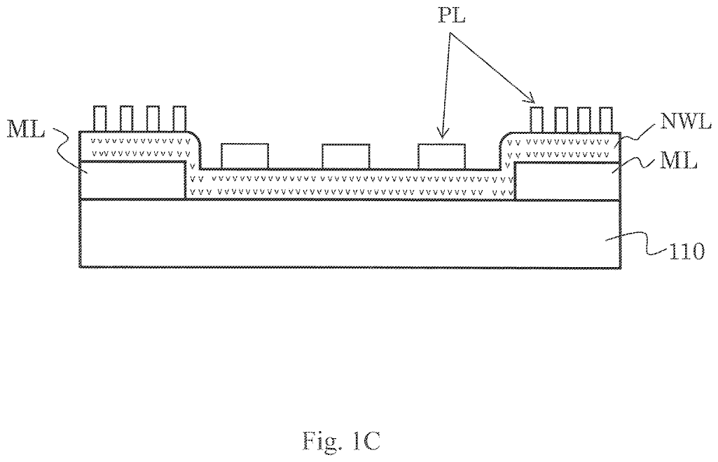

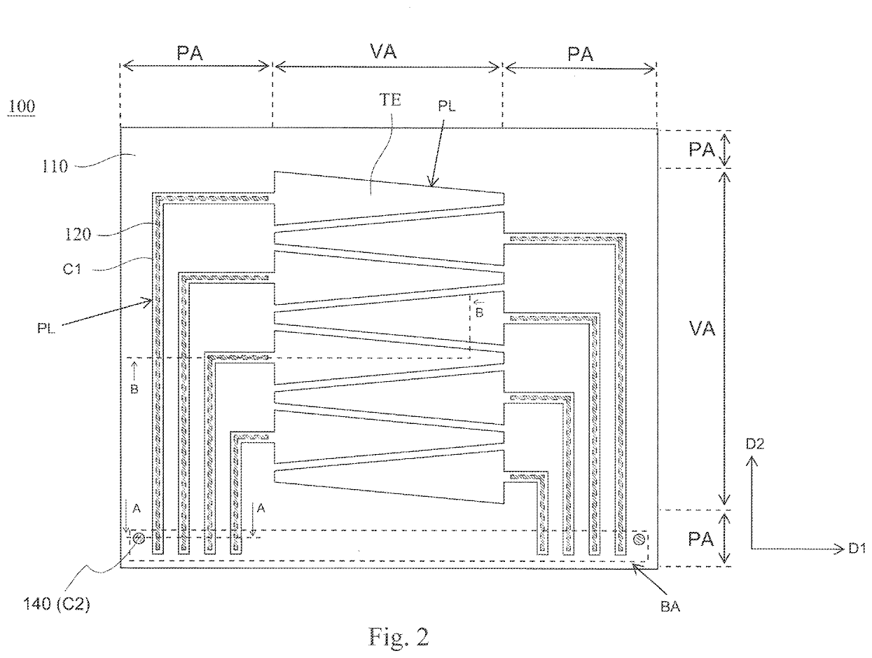

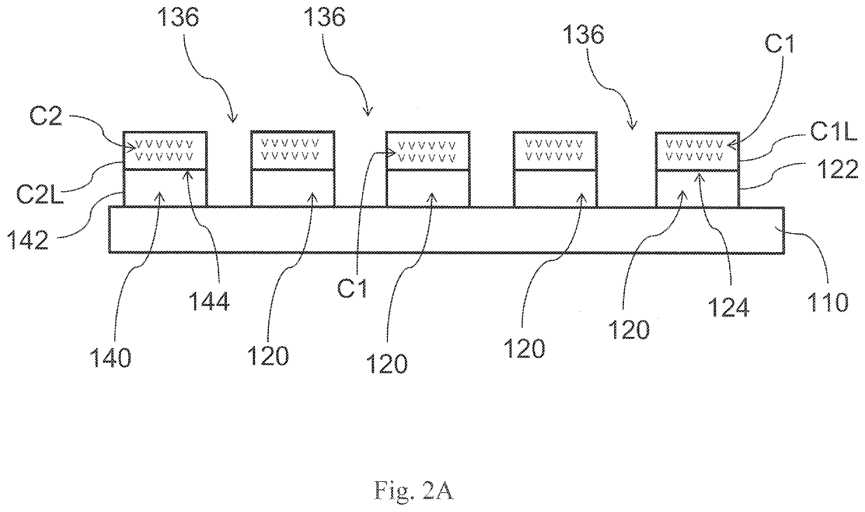

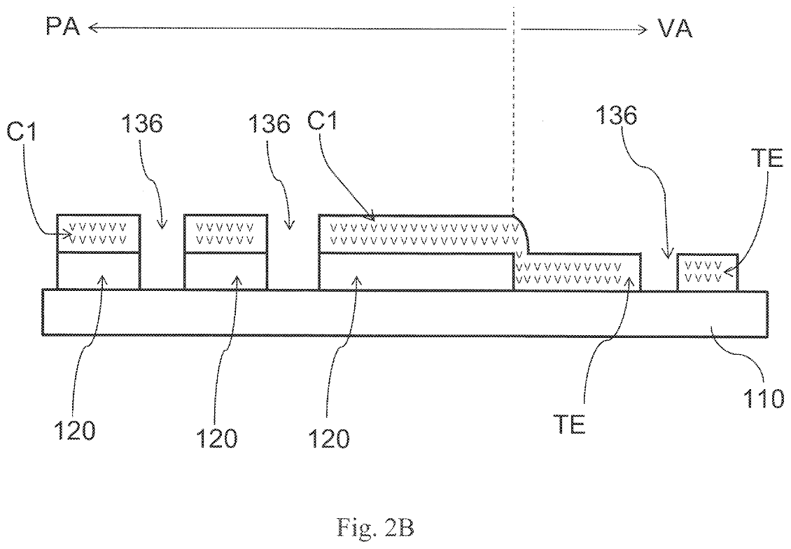

Please refer to FIG. 2 to FIG. 2B first, which are a schematic top view and cross-sectional views of a touch panel 100 according to some embodiments of the present disclosure. The touch panel 100 includes a substrate 110, a peripheral wire 120, a first covering C1, a patterned layer PL, and a touch sensing electrode TE. Referring to FIG. 2, the substrate 110 has a visual area VA and a peripheral area PA. The peripheral area PA is disposed on a side of the visual area VA. For example, the peripheral area PA may be a frame-shaped area disposed around the visual area VA (that is, the peripheral area PA covers the right, left, upper, and lower sides). But, in other embodiments, the peripheral area PA may be an L-shaped area disposed on the left and lower sides of the visual area VA. Also as shown in FIG. 2, in this embodiment, there are eight sets of peripheral wires 120 and the corresponding first coverings C1 are disposed in the peripheral area PA of the substrate 110. The touch sensing electrode TE is disposed on the substrate 110 in the visual area VA.

The touch panel 100 also includes a mark 140 and a second covering C2. Referring to FIG. 2, this embodiment has two sets of the marks 140 and the corresponding second coverings C2, which are disposed on the substrate 110 in the peripheral area PA. The number of the above-mentioned peripheral wires 120, marks 140, first coverings C1, second coverings C2, and touch sensing electrodes TE can be one or more, and the numbers drawn in the following specific embodiments and drawings are for illustrative purposes only, and the disclosure is not limited thereto.

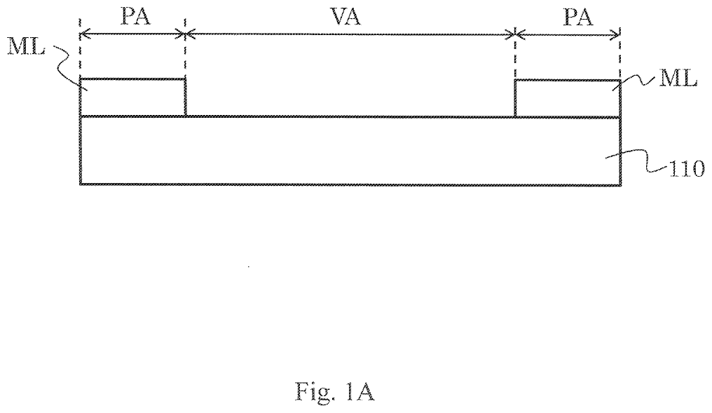

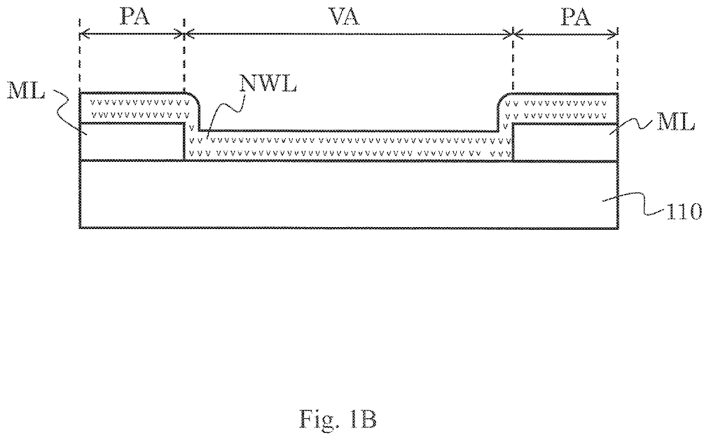

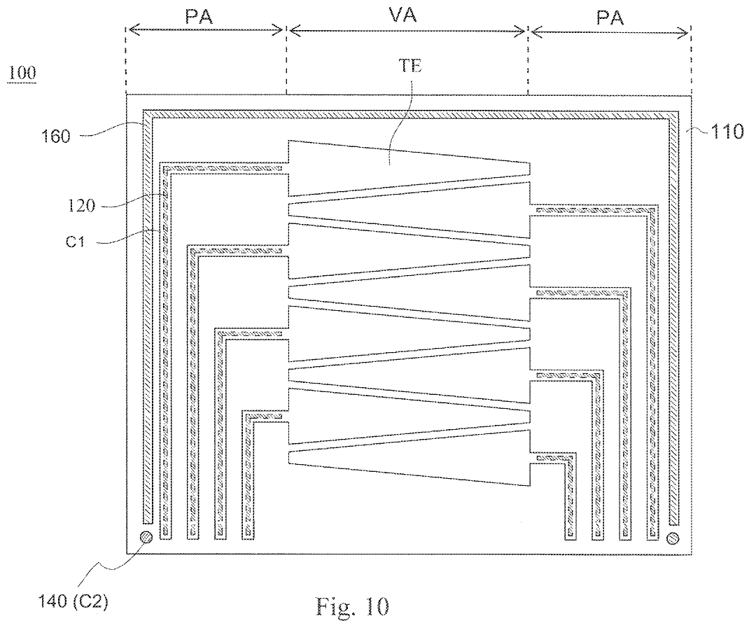

Specifically, referring to FIG. 1A to FIG. 10, the touch panel 100 in the embodiment of the present disclosure can be manufactured in the following method. Firstly, a substrate 110 is provided, which has a predefined peripheral area PA and a predefined visual area VA. Next, a metal layer ML is formed in the peripheral area PA (as shown in FIG. 1A); then a metal nanowires layer NWL is formed in the peripheral area PA and visual area VA (as shown in FIG. 1B); then a patterned layer PL is formed on the metal nanowires layer NWL (as shown in FIG. 10); then a patterning step is performed according to the patterned layer PL to form a patterned metal layer ML and a patterned metal nanowires layer NWL. This will be described in more detail below.

Please refer to FIG. 1A, a metal layer ML is formed in the peripheral area PA of the substrate 110. The metal layer ML can be subsequently patterned to become a peripheral wire 120. In detail, in some embodiments of the present disclosure, the metal layer ML may be made of metal with better conductivity, preferably a single-layer metal structure, such as a silver layer, a copper layer, etc. or a multilayer conductive structure, such as molybdenum/aluminum/molybdenum, copper/nickel, titanium/aluminum/titanium, molybdenum/chromium, etc. The above-mentioned metal structure is preferably opaque. For example, the transmittance of visible light (such as having a wavelength between 400 nm-700 nm) is less than about 90%.

In this embodiment, the above-mentioned metal can be formed on the substrate 110 by a sputtering method (for example, but not limitation, a physical sputtering, a chemical sputtering, etc.). The metal layer ML can be directly and selectively formed in the peripheral area PA instead of the visual area VA, or the entire surface can be formed in the peripheral area PA and visual area VA, and then the metal layer ML located in the visual area VA can be removed by an etching and other steps.

In one embodiment, the metal layer ML (e.g., a copper layer) is deposited on the substrate 110 in the peripheral area PA through electroless plating. Electroless plating uses a suitable reducing agent without external current. Electroless plating makes the metal ions in the plating solution reduce to metal under the catalysis of a metal catalyst and plate on the surface. This process is called electroless plating, also called chemical plating or autocatalytic plating. Therefore, the metal layer ML of this embodiment may also be referred to as an electroless plating layer, an electroless plating layer, or an autocatalytic plating layer. Specifically, for example, a plating solution in which the main component is copper sulfate can be used, and the composition of the plating solution can be but is not limited to: copper sulfate with a concentration of 5 g/L, ethylenediaminetetraacetic acid with a concentration of 12 g/L, and formaldehyde with a concentration of 5 g/L, the pH value of the electroless copper plating solution is adjusted to about 11 to 13 with sodium hydroxide, the bath temperature is about 50 to 70° C., and the immersion reaction time is 1 to 5 minutes. In one embodiment, a catalytic layer (not shown) can be firstly formed on the substrate 110 in the peripheral area PA. Since there is no catalytic layer in the visual area VA, the metal layer ML is only deposited in the peripheral area PA and not formed in the visual area VA. During the electroless plating reaction, copper material can nucleate on the catalytic layer having catalytic/activation ability, and then a copper film can continue to grow by the autocatalysis of copper.

Next, referring to FIG. 1B, the metal nanowires layer NWL including metal nanowires is coated in the peripheral area PA and the visual area VA, in which the metal nanowires layer NWL is, for example, a silver nanowires layer, a gold nanowires layer, or a copper nanowires layer. The first portion of the metal nanowires layer NWL is located in the visual area VA. The first portion is mainly formed on the substrate 110, and the second portion, which is in the peripheral area PA, is mainly formed on the metal layer ML. The specific method in this embodiment is as follows. A dispersion or ink including metal nanowires is formed on the substrate 110 by a coating method and then dried to cover the substrate 110 and the aforementioned metal layer ML with the metal nanowires, thereby forming into the metal nanowires layer NWL disposed on the substrate 110 and the aforementioned metal layer ML. After the above curing/drying step, the solvent and other substances are volatilized, and the metal nanowires are randomly distributed on the surface of the substrate 110 and the aforementioned metal layer ML. Preferably, the metal nanowires layer NWL is formed such that the metal nanowires are fix on, and do not fall off of, the surfaces of the substrate 110 and the aforementioned metal layer ML, and the metal nanowires can contact each other to provide continuous current paths, thereby forming a conductive network.

In the embodiment of the present disclosure, the aforementioned dispersion may be water, alcohol, ketone, ether, hydrocarbon, or aromatic solvent (benzene, toluene, xylene, etc.). The aforementioned dispersion may also include an additive, a surfactant, or an adhesive, such as carboxymethyl cellulose (CMC), hydroxyethyl cellulose (HEC), hydroxypropyl methylcellulose (HPMC), sulfonate, sulfate, disulfonate, sulfosuccinate, phosphate, fluorine-containing surfactant, etc. The dispersion or ink including metal nanowires can be formed on the surface of the substrate 110 and the aforementioned metal layer ML in any manners, including but not limited to, screen printing, nozzle coating, roller coating, etc. In an embodiment, a roll-to-roll (RTR) process may be used to coat the dispersion or ink including metal nanowires on the surfaces of the continuously supplied substrate 110 and the aforementioned metal layer ML.

As used herein, “metal nanowires” is a collective term which refers to a collection of metal wires including multiple-element metals, metal alloys, or metal compounds (including metal oxides). The number of metal nanowires does not affect the scope of protection claimed in the present disclosure. At least one cross-sectional dimension (i.e., the diameter of the cross-section) of a single metal nanowire is less than about 500 nm, preferably less than about 100 nm, and more preferably less than about 50 nm. The metal nanostructure referred to as “wire” in the present disclosure mainly has a high aspect ratio, for example, between about 10 and 100,000. In more detail, the aspect ratio (length:the diameter of the cross-section) can be greater than about 10, preferably greater than about 50, and more preferably greater than about 100. The metal nanowire can be any metal, including but not limited to silver, gold, copper, nickel, and gold-plated silver. Other terms, such as silk, fiber, tube, etc., if they also have the above-mentioned size and high aspect ratio, are also covered by the present disclosure.

Next, please refer to FIG. 10, a patterned layer PL is formed on the metal nanowires layer NWL. In one embodiment, the patterned layer PL uses flexography technology to directly form the material with a patterned structure on the metal nanowires layer NWL. In other words, the patterned layer PL already has a specific pattern when the patterned layer PL is formed on the working surface (in this embodiment, the metal nanowires layer NWL is the working surface), so there is no need to perform a patterning step for the coated material. According to one or more specific examples of the present disclosure, the patterned layer PL uses relief printing, gravure printing, screen printing, etc. to transfer the material to be printed onto the metal nanowires layer NWL according to a specific pattern. The patterned layer PL manufactured according to the aforementioned method can have a printed side surface, which is different from the side surface that is formed through traditional processes such as exposure, development, or etching. In one embodiment, photoresist, dry film, etc. can be used to manufacture the patterned layer PL by photolithography and etching processes.

The patterned layer PL can be formed in the peripheral area PA according to the aforementioned method and can also be formed in the peripheral area PA and the visual area VA. The patterned layer PL (also referred to as the second patterned layer) located in the peripheral area PA is mainly used as an etching mask for the peripheral area PA for patterning the metal nanowires layer NWL in the peripheral area PA and the metal layer ML in the following steps. The patterned layer PL (also referred to as the first patterned layer) located in the visual area VA is mainly used as an etching mask of the visual area VA for patterning the metal nanowires layer NWL in the visual area VA in the following steps.

The embodiment of the present disclosure does not limit the material of the patterned layer PL (i.e., the aforementioned material to be printed). For example, the material of the patterned layer PL includes the following: various photoresist materials, undercoating materials, outer coating materials, protective layer materials, insulating layers materials, etc., and the material of the patterned layer PL can be phenolic resin, epoxy resin, acrylic resin, polyurethane (PU) resin, acrylonitrile butadiene styrene (ABS) resin, amino resin, silicone resin, etc. In terms of material properties, the material of the patterned layer PL can be photo-curing materials or thermal-curing materials. In one embodiment, the material of the patterned layer PL has a viscosity of about 200-1500 cps and a solid content of about 30-100%.

Subsequently, the patterning step is performed, and the touch panel 100 as shown in FIG. 2 can be manufactured after the patterning step. In one embodiment, in the peripheral area PA, an etching solution that can simultaneously etch the metal nanowires layer NWL and the metal layer ML is used, and the etching mask formed by the patterned layer PL (also referred to as the second patterned layer) is used in the same process to manufacture the patterned metal layer ML and the patterned metal nanowires layer NWL. As shown in FIG. 2 and FIG. 2B, the patterned metal layer ML made in the peripheral area PA is the peripheral wire 120, and the patterned metal nanowires layer NWL made in the peripheral area PA is an etching layer. The etching layer is located on the peripheral wire 120, so it can also be referred to as a first covering C1. In other words, after the patterning step, the peripheral area PA includes the first covering C1 formed by the second part of the metal nanowires layer NWL and the peripheral wire 120 formed by the metal layer ML. In another embodiment, in the peripheral area PA, the etching layer, which includes the second portion of the metal nanowires layer NWL, and the peripheral wire 120 and the mark 140, which include the metal layer ML, can be manufactured (please refer to FIG. 2, FIG. 2A and FIG. 2B). The etching layer may include a first covering C1 and a second covering C2. The first covering C1 is correspondingly disposed on the peripheral wire 120, and the second covering C2 is correspondingly disposed on the mark 140. In one embodiment, the simultaneous etching of the metal nanowires layer NWL and the metal layer ML indicates that the etching rate ratio of the metal nanowires layer NWL to the metal layer ML is about 0.1-10, or about 0.01-100.

According to a specific embodiment, in the case that the metal nanowires layer NWL is a nanosilver layer, and the metal layer ML is a copper layer, the etching solution can be used to etch copper and silver. For example, the composition of the etching solution includes hydrogen peroxide, for example, about 1.0-2.0, 5.0-10.0, 20.0-40.0, or 1.0-10.0 wt %; an acid, for example, about 1.0-5.0, 1.0-20.0 or 0.1-10.0 wt %; a metal corrosion inhibitor, for example, about 0.1-10.0, 1.0-10.0, or 2.0-7.0 wt %; a stabilizer, for example, about 0.1-10.0, 1.0-10.0, or 3.0-8.0 wt %, and a balance of a solvent. The acid may include an organic acid, an inorganic acid, or combinations thereof, in which the organic acid may include a carboxylic acid, a dicarboxylic acid, a tricarboxylic acid, an alkyl carboxylic acid, an acetic acid, an oxalic acid, a benzenehexacarboxylic acid, a formic acid, a chloroacetic acid, a benzoic acid, a trifluoroacetic acid, a propionic acid, a butyric acid, or combinations thereof. The inorganic acid may include a phosphoric acid, a nitric acid, a hydrochloric acid, or combinations thereof. The metal corrosion inhibitor may include a nitrogen-containing organic compound, a sulfur-containing organic compound, a hydroxyl-containing organic compound with surface activity, mercaptobenzothiazole, benzotriazole, methylbenzotriazole, or combinations thereof. The stabilizer may include ethylenediaminetetraacetic acid, diethylenetriaminepentaacetic acid, hydroxyethylethylene diaminetriacetic acid, diethylaminopentaacetic acid, N-(2-hydroxyethyl)ethylenediaminetriacetic acid, polyacrylamide, or combinations thereof. According to a specific embodiment, in the case in which the metal nanowires layer NWL is a nanosilver layer and the metal layer ML is an electroless copper plating layer, the etching solution can be used to etch copper and silver. For example, the composition of the etching solution includes about 1.0-10.0 wt % of hydrogen peroxide, about 1.0-5.0 wt % of an acid, about 2.0-7.0 wt % of a metal corrosion inhibitor, about 3.0-8.0 wt % of a stabilizer, and a balance of a solvent. According to a specific embodiment, in the case in which the metal nanowires layer NWL is a nanosilver layer and the metal layer ML is an electroless copper-nickel layer, the etching solution can be used to etch copper-nickel and silver. For example, the composition of the etching solution includes about 0.2-10.0 wt % of hydrogen peroxide, about 1.0-20.0 wt % of an acid, about 2.0-5.0 wt % of a metal corrosion inhibitor, about 3.0-5.0 wt % of a stabilizer, and a balance of a solvent.

The patterning step may also include simultaneously patterning the metal nanowires layer NWL in the visual area VA. In other words, as shown in FIG. 10, the etching mask formed with the patterned layer PL (i.e., the first patterned layer) can be used to pattern the first portion of the metal nanowires layer NWL in the visual area VA through the aforementioned etching solution. The touch sensing electrode TE of this embodiment is disposed in the visual area VA, and the touch sensing electrode TE can be electrically connected to the peripheral wire 120. Specifically, the touch sensing electrode TE can also be the metal nanowires layer including metal nanowires. That is, the patterned metal nanowires layer NWL forms the touch sensing electrode TE in the visual area VA and forms the first covering C1 in the peripheral area PA. Therefore, the touch sensing electrode TE can electrically connect with the peripheral wire 120 for signal transmission through the first covering C1 contacting the peripheral wire 120. The metal nanowires layer NWL also forms the second covering C2 in the peripheral area PA, and the second covering C2 is disposed on the top surface 144 of the mark 140. The mark 140 can be widely interpreted as a pattern having non-electrical functions, but the mark 140 is not limited thereto. In some embodiments of the present disclosure, the peripheral wire 120 and the mark 140 can be made of the same layer of the metal layer ML (i.e., both are the same metal material, such as the aforementioned electroless copper layer or the sputtered copper layer). The touch sensing electrode TE, the first covering C1, and the second covering C2 can be made of the same layer of the metal nanowires layer NWL.

In one embodiment, the width of the pattern located in the visual area VA can be at least 100 μm, so the aforementioned etching solution will not cause side etching problem on the metal nanowires layer NWL in the visual area VA.

In another embodiment, during the patterning step, a selective etching solution is used for a different-steps etching in the peripheral area PA. The etching solution is only used to etch the metal nanowires layer NWL but not the metal layer ML. In detail, the etching solution is firstly used to etch the metal nanowires layer NWL in the peripheral area PA and the visual area VA, and then another etching solution is used to etch the metal layer ML in the peripheral area PA. In this way, the etching mask formed by the patterned layer PL (also referred to as the second patterned layer) is used to manufacture the patterned metal layer ML and the patterned metal nanowires layer NWL in the same process. As shown in FIG. 2 and FIG. 2B, the patterned metal layer ML made in the peripheral area PA is the peripheral wire 120, and the patterned metal nanowires layer NWL is the etching layer. The etching layer is located on the peripheral wire 120, so the etching layer can also be referred to as the first covering C1. In other words, after the patterning step, the peripheral area PA forms the first covering C1 formed by the second portion of the metal nanowires layer NWL and the peripheral wire 120 formed by the metal layer ML. In another embodiment, in the peripheral area PA, the etching layer formed from the second portion of the metal nanowires layer NWL, and the peripheral wire 120 and the mark 140 formed from the metal layer ML can be manufactured (please refer to FIGS. 2, 2A and 2B). The etching layer may include the first covering C1 and the second covering C2. The first covering C1 is correspondingly disposed on the peripheral wire 120, and the second covering C2 is correspondingly disposed on the mark 140.

According to another specific embodiment, in the case in which the metal nanowires layer NWL is a nanosilver layer and the metal layer ML is a copper layer, the etching solution is only used to etch silver and not copper. For example, the composition of the etching solution includes 0.01-50 wt % of hydrogen peroxide, 0.1-10 wt % of a metal corrosion inhibitor, 0.1-10 wt % of a stabilizer, and a balance of a solvent. The metal corrosion inhibitor may include a nitrogen-containing organic compound, a sulfur-containing organic compound, a hydroxyl-containing organic compound, an organic compound having surface activity, mercaptobenzothiazole, benzotriazole, methylbenzotriazole, or combinations thereof. The stabilizer may include ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

Since the aforementioned etching solution does not etch the metal layer ML, the problem of incomplete etching of the metal nanowires layer NWL in the peripheral area PA and the visual area VA can be avoid or the problem of side etching of the metal layer ML in the peripheral area PA can be avoided.

After the patterning step, the method may further include removing the patterned layer PL.

In addition, the film layer and the metal nanowires layer NWL (such as the first covering C1, the second covering C2, or the touch sensing electrode TE) can be coated before or after the aforementioned etching step to form a composite structure. The composite structure has some specific chemical properties, mechanical properties, and optical properties. For example, the adhesion of the touch sensing electrode TE, the first covering C1, the second covering C2, and the substrate 110 can provide improve or better mechanical strength can be obtained. Therefore, the film layer can also be referred to as a matrix. Furthermore, some specific polymers are used to make the film layer, so that the touch sensing electrode TE, the first covering C1, and the second covering C2 have additional surface protection against scratches and abrasion. In this case, the film layer can be referred to as an overcoat, and the film layer can be made by using a material, such as polyacrylate, epoxy resin, polyurethane, polysilane, polysiloxane, poly(silicon-acrylic acid), etc., to provide the touch sensing electrode TE, the first covering C1, and the second covering C2 with higher surface strength and improve scratch resistance. However, the above is only to describe the possibility of other additional functions/names of the film layer and is not intended to limit the present disclosure. It is worth noting that, in one embodiment, the polymer used to make the film layer can penetrate between the metal nanowires to form a filler before it is cured or in a pre-cured state. After the polymer is cured, the metal nanowires would be embedded in the film layer. In other words, the present disclosure does not limit the structure between the film layer and the metal nanowires layer NWL (for example, the first covering C1, the second covering C2, or the touch sensing electrode TE).

In one embodiment, the film layer can be a ultraviolet-curable (UV-curable) material with high transmission, low dielectric constant, and low haze to maintain the transmission of the touch sensing electrode TE in the visual area VA between about 88% and 94%, the haze is between about 0 and 2, and the surface resistance is between about 10 and 150 ohm/square. The optoelectronic properties of the film layer make the combination of the film layer and the metal nanowires layer NWL meet the optical and touch sensing requirements in the visual area VA. For example, the transmission of the visible light (such as having a wavelength between about 400 nm and 700 nm) of the composite structure may be greater than about 80%, and the surface resistance is between about 10 and 1000 ohms/square. Preferably, the visible light of the composite structure has a transmission greater than about 85%, and the surface resistance is between about 50 to 500 ohms/square. In this embodiment, a curing step (such as UV curing) may also be further included.

FIG. 2 shows a schematic view of the touch panel 100 according to an embodiment of the present disclosure. FIG. 2A and FIG. 2B are cross-sectional views taken along the line A-A and line B-B of FIG. 2, respectively. Please refer to FIG. 2A firstly. As shown in FIG. 2A, the peripheral wire 120 and the mark 140 are both disposed in the peripheral area PA. The first covering C1 is formed to cover the top surface 124 of the peripheral wire 120, and the second covering C2 is formed to cover the top surface 144 of the mark 140. In some embodiments of the present disclosure, the metal nanowire may be a silver nanowire. For the convenience of description, the cross-section of the peripheral wire 120 and the mark 140 in the present disclosure is a quadrilateral (for example, the rectangle drawn in FIG. 2A), but the structure and number of the side 122 and the top surface 124 of the peripheral wire 120, and the side 142 and the top surface 144 of the mark 140 can be changed according to actual applications, which are not limited by the present description and drawings in the present disclosure.

In this embodiment, the mark 140 is disposed in the bonding area BA of the peripheral area PA, which butt joint the bit alignment mark. That is, in the step of connecting an external circuit board, such as a flexible printed circuit board 170, to the touch panel 100 (i.e., the bonding step), the mark is used for bit alignment to connect the flexible printed circuit board 170 to the touch panel 100 (please refer to FIG. 2). However, the present disclosure does not limit the position or function of the mark 140. For example, the mark 140 can be any checkmark, pattern, or label required in the manufacturing process, which is within the scope of the present disclosure. The mark 140 can have any possible shape, such as a circle, a quadrilateral, a cross, an L-shape, a T-shape, and so on. On the other hand, the portion of the peripheral wire 120 that extends to the bonding area BA can also be referred to as a bonding section. Similar to the previous embodiment, the top surface of the bonding area BA is also covered by the first covering C1.

As shown in FIG. 2A and FIG. 2B, in the peripheral area PA, there is a non-conductive region 136 between adjacent peripheral wires 120 to electrically block the adjacent peripheral wires 120 to avoid short circuits. That is to say, the non-conductive region 136 is between the side surfaces 122 of the adjacent peripheral wires 120, and in this embodiment, the non-conductive region 136 is a gap to isolate the adjacent peripheral wires 120. By using the patterned layer PL, the aforementioned etching solution can be used to make the aforementioned gap. Therefore, the side 122 of the peripheral wire 120 and the side C1L of the first covering C1 are a common etching surface and are aligned with each other. That is to say, the patterned layer PL is used as a reference. The side 122 of the peripheral wire 120 and the side C1L of the first covering C1 are formed in the same etching step according to the printed side of the patterned layer PL, so the printed side and the common etching surface are aligned with each other. Similarly, the side 142 of the mark 140 and the side C2L of the second covering C2 are a common etching surface and are aligned with each other. Also, the printed side of the patterned layer PL is aligned with the common etching surface. In one embodiment, the side C1L of the first covering C1 and the side C2L of the second covering C2 would not have the metal nanowires due to the above etching step. Furthermore, the patterned layer PL, the peripheral wire 120, and the first covering C1 have the same or similar patterns and dimensions, such as long and straight patterns, and the same or similar widths. The patterned layer PL, the mark 140, and second covering C2 also have the same or similar patterns and dimensions, such as circles with the same or similar radius, quadrilaterals with the same or similar side length, or other same or similar crosses, L-shapes, T-shapes, and other patterns.

As shown in FIG. 2B, in the visual area VA, there is a non-conductive region 136 between the adjacent touch sensing electrodes TE to electrically block the adjacent touch sensing electrodes TE to avoid short circuits. That is to say, the non-conductive region 136 is between the sidewalls of the adjacent touch sensing electrodes TE, and in this embodiment, the non-conductive region 136 is a gap to isolate the adjacent touch sensing electrodes TE. In one embodiment, the aforementioned etching method may be used to form the gap between the adjacent touch sensing electrodes TE. In this embodiment, the touch sensing electrode TE and the first covering C1 can be made by using the metal nanowires layer NWL which is in the same layer (such as a silver nanowire layer, or a composite layer formed by a silver nanowire layer and a film layer). Therefore, at the junction of the visual area VA and the peripheral area PA, the metal nanowires layer NWL form a climbing structure to facilitate the formation of the metal nanowires layer NWL and cover the top surface 124 of the peripheral wire 120, thereby forming the first covering C1.

In some embodiments of the present disclosure, the first covering C1 of the touch panel 100 is disposed on the top surface 124 of the peripheral wire 120, and the first covering C1 and the peripheral wire 120 are formed in the same etching process. Therefore, it is possible to reduce or avoid the need to reserve the alignment bit error area in the manufacturing process, so the width of the peripheral area PA is reduced, thereby achieving the narrow bezel requirement of the display. Moreover, the etching solution disclosed in the present disclosure etch into different material layers corresponding to different circuits in different areas, such as the metal/nanosilver in the peripheral area PA and the nanosilver in the visual area VA. The obtained circuits have good linearity and the etching solution has good side etching amount (critical dimension (CD) bias) control, and no residual material in the non-conductive region 136. Specifically, in some embodiments of the present disclosure, the width of the peripheral wire 120 of the touch panel 100 is about 5 μm to 30 μm, and the distance between the adjacent peripheral wires 120 is about 5 μm to 30 μm; or the width of the peripheral wire 120 of the touch panel 100 is about 3 μm to 20 μm, and the distance between the adjacent peripheral wires 120 is about 3 μm to 20 μm. The width of the peripheral area PA can also reach a size less than 2 mm, which is reduced by about 20% in the frame size or more compared with traditional touch panel products.

In some embodiments of the present disclosure, the touch panel 100 further has the second covering C2 and the mark 140, in which the second covering C2 is disposed on the top surface 144 of the mark 140, and the second covering C2 and mark 140 are formed in the same etching process.

FIG. 3 shows the assembly structure of the flexible printed circuit board 170 and the touch panel 100 after the bit alignment. The electrode pads (not shown) of the flexible printed circuit board 170 can be made by a conductive adhesive (not shown, such as an anisotropic conductive adhesive) and electrically connect to the peripheral wire 120 on the substrate 110 in the bonding area BA. In some embodiments, the first covering C1 located in the bonding area BA may have an opening (not shown) to expose the peripheral wire 120, and the conductive adhesive (such as an anisotropic conductive adhesive) may be filled into the opening of the first covering C1 to directly contact the peripheral wire 120, thereby forming a conductive path. In this embodiment, the touch sensing electrode TE is arranged in a non-staggered arrangement. For example, the touch sensing electrode TE is an elongated electrode extending along the first direction D1 and having a variable width in the second direction D2 and does not intersect with each other. However, in other embodiments, the touch sensing electrode TE may have an appropriate shape. Thus, the shape or arrangement of the touch sensing electrode TE should not limit the scope of the present disclosure. In this embodiment, the touch sensing electrode TE is a single-layer (single-sided) configuration, in which the touch position can be obtained by detecting capacitance changes of each touch sensing electrode TE.

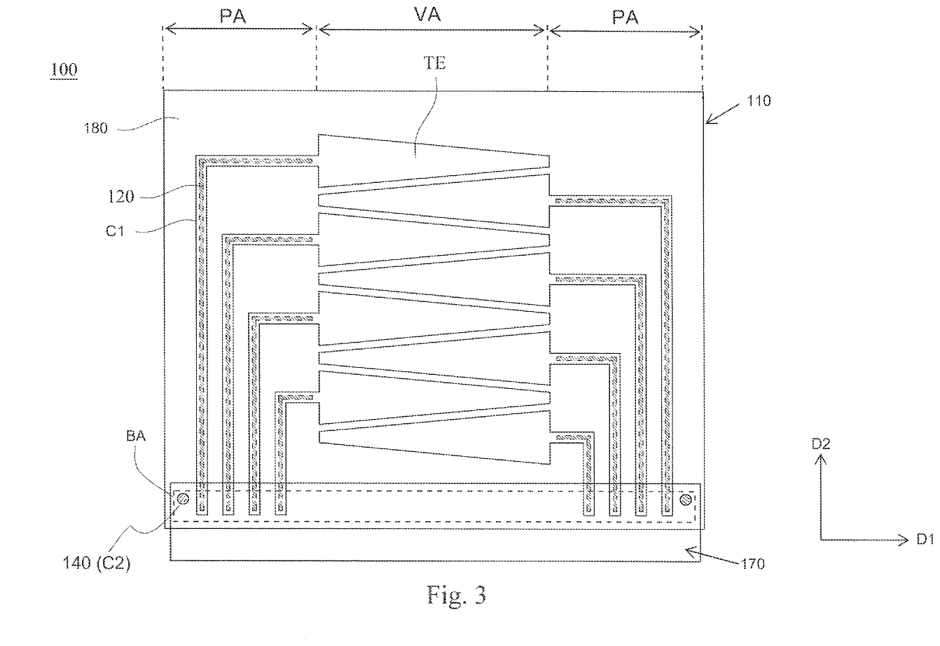

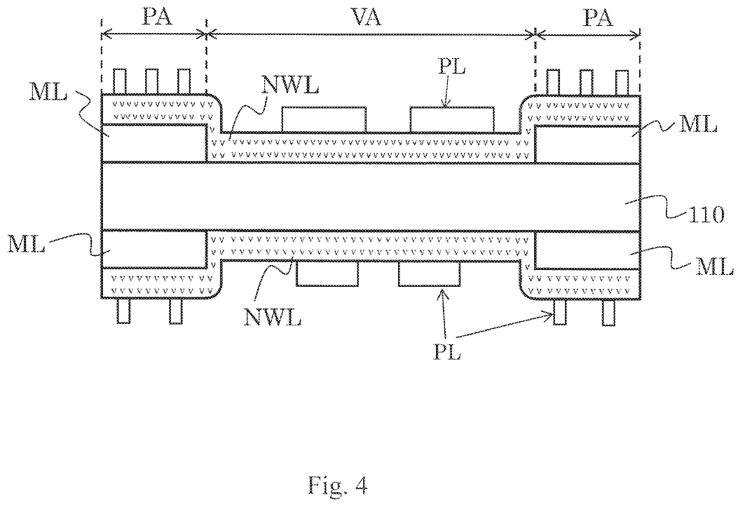

The present disclosure can also apply the above method to a double-sided substrate to manufacture a double-sided touch panel 100. For example, a double-sided substrate can be manufactured by the following method. Firstly, a substrate 110 is provided, on which there is a predefined peripheral area PA and a predefined visual area VA. Next, a metal layer ML is formed on a first surface and a second surface of the substrate 110, in which the second surface is opposite to the first surface, such as the top surface and the lower surface, and the metal layer ML is located in the peripheral area PA; then the metal nanowire layers NWL are respectively formed on the first and second surfaces in the peripheral area PA and the visual area VA; then the patterned layers PL are formed on the metal nanowires layer NWL on the first and second surfaces, respectively; then according to the patterned layers PL, the first and second surfaces are patterned with the aforementioned etching solution to form the touch sensing electrode TE and the peripheral wire 120 on the first and second surfaces, and the first covering C1 covers the peripheral wire 120, as shown in FIG. 4. The specific implementation of the present embodiment (such as the composition of the etching solution) is similar to the foregoing description and will not be repeated herein.

According to some embodiments of the present disclosure, another double-sided touch panel is disclosed. The manufacturing method of the double-sided touch panel can be formed by overlapping two sets of single-sided touch panels in the same side or in the different sides. Take the different sides overlap as an example. The touch electrodes of the first set of the single-sided touch panel are disposed facing upwards (for example, closest to the user, but not limited thereto), and the touch electrodes of the second set of the single-sided touch panel are disposed facing downwards (for example, farthest away from the user, but not limited thereto). Two substrates of two sets of the single-sided touch panels are assembled and fixed with optical cement or other similar adhesives to form a double-sided touch panel. The specific implementation of the present embodiment (such as the composition of the etching solution) is similar to the foregoing description and will not be repeated herein.

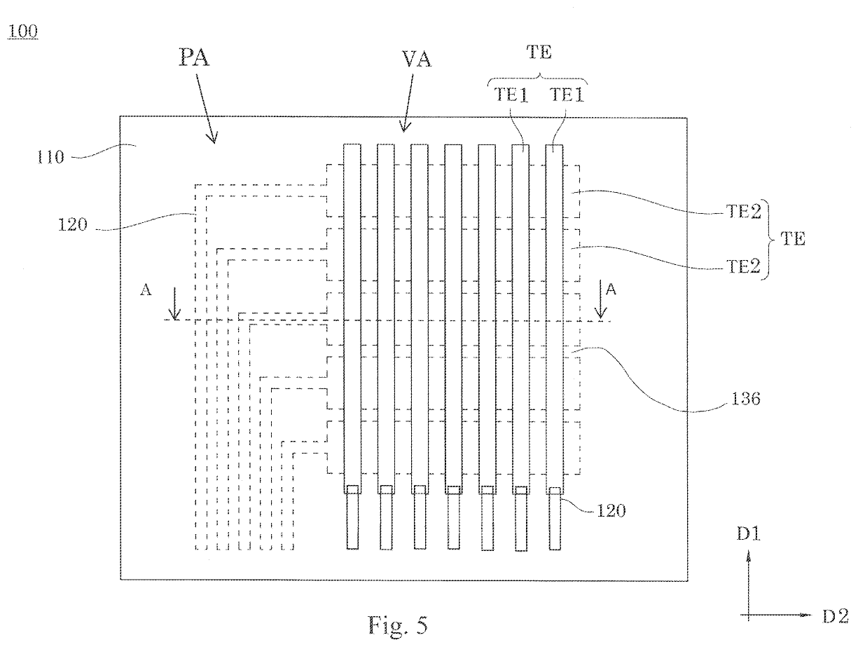

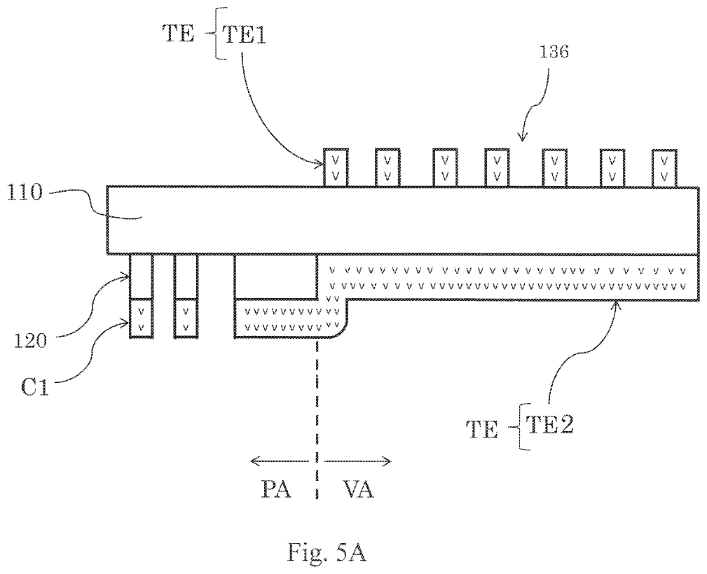

FIG. 5 is the touch panel 100 according to an embodiment of the present disclosure, which includes a substrate 110, touch sensing electrodes TE formed on the upper and lower surfaces of the substrate 110 (i.e., both the first touch sensing electrode TE1 and the second touch sensing electrode TE2 are formed by the metal nanowires layer NWL) and a peripheral wire 120 formed on the upper and lower surfaces of the substrate 110. For simplicity of the drawing, the first and second coverings C1 and C2 are not shown in FIG. 5. It can be seen from the top surface of the substrate 110 that the first touch sensing electrode TE1 in the visual area VA and the peripheral wire 120 in the peripheral area PA are electrically connected to each other to transmit signals. Similarly, it can be seen from the bottom surface of the substrate 110 that the second touch sensing electrode TE2 in the visual area VA and the peripheral wire 120 in the peripheral area PA are electrically connected to each other to transmit signals. In addition, the first touch sensing electrode TE1 and the second touch sensing electrode TE2 are formed in a staggered arrangement. The peripheral wire 120 includes the metal layer ML, on which the first covering C1 is formed (also shown in FIG. 5A). This embodiment further also has a mark 140 and a second covering C2 corresponding to the mark 140 disposed on the substrate 110 in the peripheral area PA. For details, please refer to the foregoing description.

Please refer to FIG. 5 with the cross-sectional view shown in FIG. 5A. In one embodiment, the first touch sensing electrode TE1 is approximately located in the visual area VA, and the first touch sensing electrode TE1 may include multiple long and straight sensing electrodes extending along the same direction (such as the first direction D1). The area removed by the aforementioned etching solution can be defined as the non-conductive region 136 to electrically block adjacent sensing electrodes. Similarly, the second touch sensing electrode TE2 is approximately located in the visual area VA, and the second touch sensing electrode TE2 may include multiple long and straight sensing electrodes extending along the same direction (such as the second direction D2). The removal area can be defined as the non-conductive region 136 to electrically block adjacent sensing electrodes. The first touch sensing electrode TE1 and the second touch sensing electrode TE2 are structurally staggered with each other, and the two can form a touch sensing electrode TE for inductive touch or gesture control and so on.

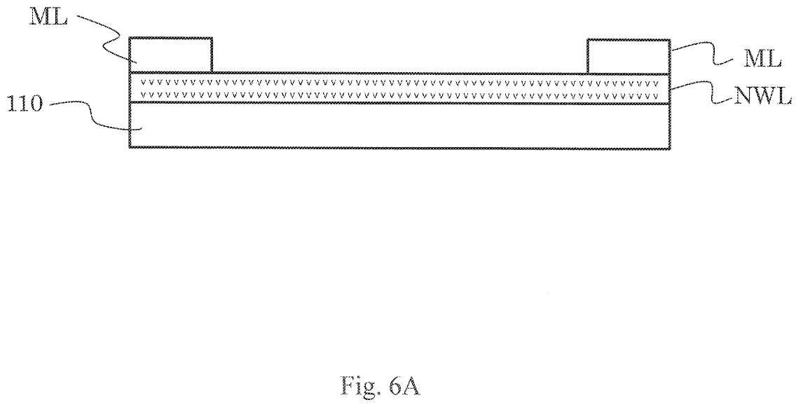

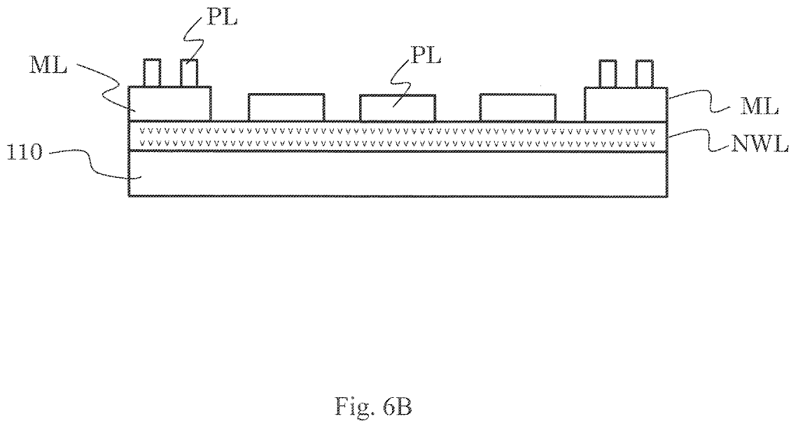

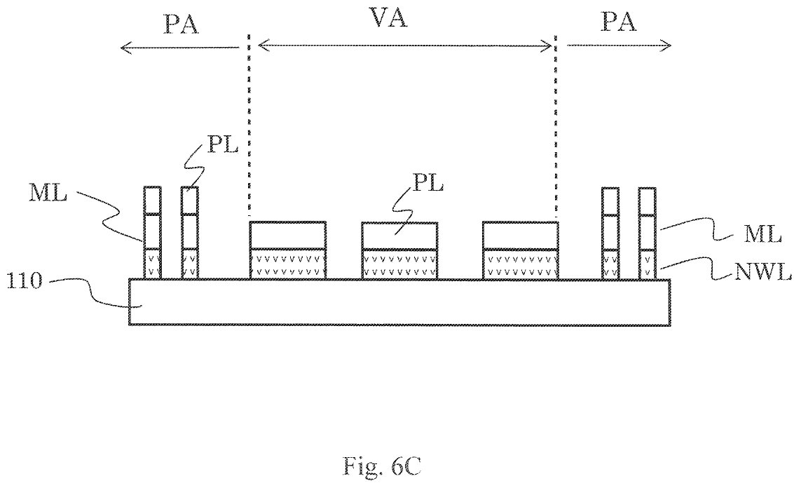

Please refer to FIGS. 6A to 6C, the touch panel in another embodiment of the present disclosure can be made in the following method. Firstly, a substrate 110 is provided, on which there is a predefined peripheral area PA and a predefined visual area VA. Next, a metal nanowires layer NWL is formed in the peripheral area PA and the visual area VA; then a metal layer ML is formed in the peripheral area PA (as shown in FIG. 6A); then a patterned layer PL is formed on the metal nanowires layer NWL (as shown in FIG. 6B); then a patterning step is performed according to the patterned layer PL to form a patterned metal layer ML and a patterned metal nanowires layer NWL (as shown in FIG. 6C). The difference between this embodiment and the previous embodiment is at least in the forming sequence of the metal layer ML and the metal nanowires layer NWL. In other words, this embodiment firstly manufactures the metal nanowires layer NWL, and then manufactures the metal layer ML. The specific implementation of this step is similar to the foregoing description. For example, the pattern of the patterned layer PL is transferred to the metal layer ML and the metal nanowires layer NWL through steps such as the etching step.

In this embodiment, the etching solution can also be used to etch copper (i.e., the metal layer ML) and silver nanowires layer (i.e., the metal nanowires layer NWL). For example, the etching solution includes hydrogen peroxide, for example, about 1.0-2.0, 5.0-10.0, 20.0-40.0, or 1.0-5.0 wt %; an acid, for example, about 0.1-0.6, 1.0-5.0, 1.0-20.0 or 0.1-10.0 wt %; a metal corrosion inhibitor, for example, about 0.1-10.0, 1.0-10.0, or 2.0-7.0 wt %; a stabilizer, for example, about 0.1-10.0, 1.0-10.0, or 3.0-8.0 wt %; and a balance of a solvent. The acid may include an organic acid, an inorganic acid, or combinations thereof, in which the organic acid may include a carboxylic acid, a dicarboxylic acid, a tricarboxylic acid, an alkyl carboxylic acid, an acetic acid, an oxalic acid, a benzenehexacarboxylic acid, a formic acid, a chloroacetic acid, a benzoic acid, a trifluoroacetic acid, a propionic acid, a butyric acid, or combinations thereof. The inorganic acid may include a phosphoric acid, a nitric acid, a hydrochloric acid, or combinations thereof. The metal corrosion inhibitor may include a nitrogen-containing organic compound, a sulfur-containing organic compound, a hydroxyl-containing organic compound, an organic compound having surface activity, mercaptobenzothiazole, benzotriazole, methylbenzotriazole, or combinations thereof. The stabilizer may include ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof. According to a specific embodiment, when the metal nanowires layer NWL is a nanosilver layer and the metal layer ML is an electroless copper plating layer, the etching solution can be used to etch copper and silver. For example, the composition of the etching solution includes about 1.0-5.0 wt % of hydrogen peroxide, about 0.1-0.6 wt % of an acid, about 2.0-7.0 wt % of a metal corrosion inhibitor, about 3.0-8.0 wt % of a stabilizer, and a balance of a solvent. According to a specific embodiment, when the metal nanowires layer NWL is a nanosilver layer and the metal layer ML is an electroless copper-nickel layer, the etching solution can be used to etch copper-nickel and silver. For example, the composition of the etching solution includes about 0.2-10.0 wt % of hydrogen peroxide, about 0.1-10.0 wt % of an acid, about 2.0-5.0 wt % of a metal corrosion inhibitor, about 3.0-5.0 wt % of a stabilizer, and a balance of a solvent.

After the patterning step, the step of removing the patterned layer PL is also included. In specific embodiments, the patterned layer PL can be removed by organic solvents or alkaline removers, such as KOH, K₂CO₃, propylene glycol methyl ether acetate (PGMEA), and the like. In other words, after the above steps, the patterned layer PL is removed and does not remain in the structure of the product.

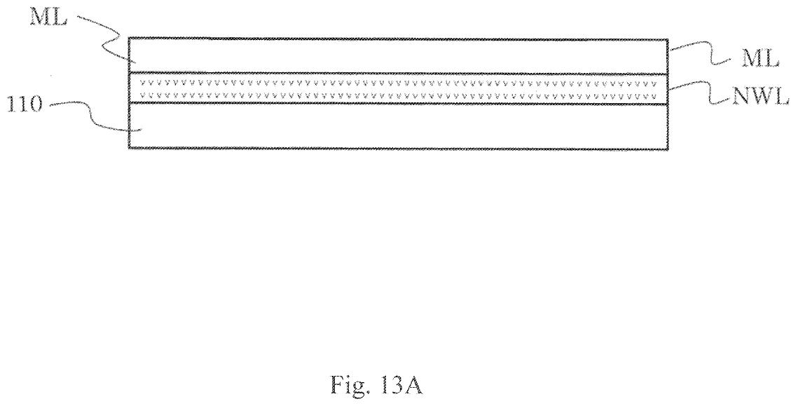

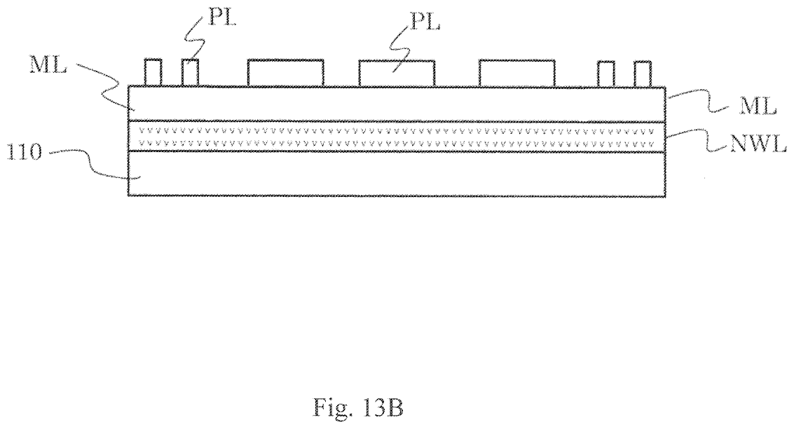

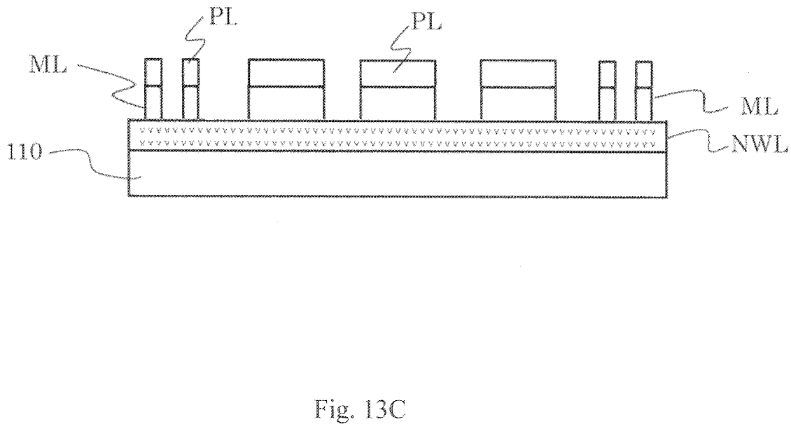

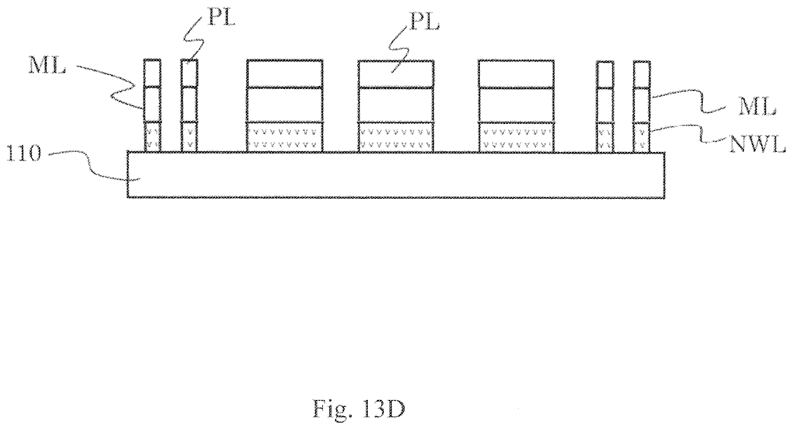

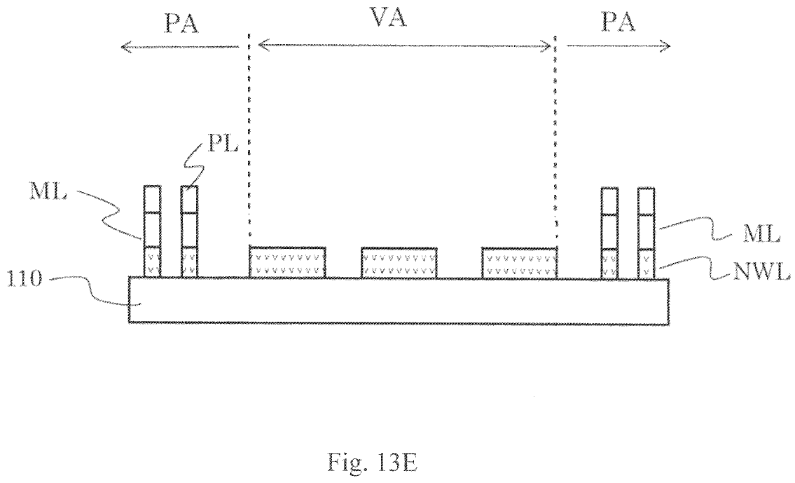

Please refer to FIGS. 13A to 13E. In another embodiment, for the aforementioned method in which the metal nanowires layer NWL is firstly manufactured and then the metal layer ML is manufactured, the touch panel can also be manufactured through the following method. Firstly, a substrate 110 is provided, on which there is a predefined peripheral area PA and a predefined visual area VA. Then, a metal nanowires layer NWL is formed in the peripheral area PA and the visual area VA. The difference from the above-mentioned embodiment is that the metal layer ML is then formed in the peripheral area PA and the visual area VA (as shown in FIG. 13A); then, a patterned layer PL is formed on the metal layer ML (as shown in FIG. 13B); and then a patterning step is performed according to the patterned layer PL to form a patterned metal layer ML and a patterned metal nanowires layer NWL. In this embodiment, when the patterning step is performed, a selective etching solution is used to perform a different-steps etching. The etching solution is only used to etch the metal nanowires layer NWL but not the metal layer ML. In detail, another etching solution is firstly used to etch the metal layer ML in the peripheral area PA and the visual area VA (as shown in FIG. 13C). The other etching solution only etches the metal layer ML but not the metal nanowires layer NWL, and then the etching solution is used to etch the metal nanowires layer NWL in the peripheral area PA and the visual area VA (as shown in FIG. 13D). The patterned layer PL in the visual area VA is removed, and another etching solution is used to continue etching the metal layer ML in the visual area VA to completely etch and remove the metal layer ML in the visual area VA (as shown in FIG. 13E). Finally, the patterned layer PL in the peripheral area PA is removed.

According to another specific embodiment, in the case in which the metal nanowires layer NWL is a nanosilver layer and the metal layer ML is a copper layer, the etching solution is only used to etch silver and not to etch copper. For example, the composition of the etching solution includes 0.01-50 wt % of hydrogen peroxide, 0.1-10 wt % of a metal corrosion inhibitor, 0.1-10 wt % of a stabilizer, and a balance of a solvent. The metal corrosion inhibitor may include a nitrogen-containing organic compound, a sulfur-containing organic compound, a hydroxyl-containing organic compound, an organic compound having surface activity, mercaptobenzothiazole, benzotriazole, methylbenzotriazole, or combinations thereof. The stabilizer may include ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

Because the aforementioned etching solution does not etch the metal layer ML, the problem of incomplete etching of the metal nanowires layer NWL in the peripheral area PA and the visual area VA can be avoided, or the problem of side etching of the metal layer ML in the peripheral area PA can be avoided.

In the step of removing the patterned layer PL, in specific embodiments, the patterned layer PL can be removed by organic solvents or alkaline removers, such as KOH, K₂CO₃, propylene glycol methyl ether acetate (PGMEA), and the like. In other words, after the above steps, the patterned layer PL would be removed and would not remain in the structure of the product.

For other detailed manufacturing methods of this embodiment, reference may be made to the foregoing description and will not be repeated herein.

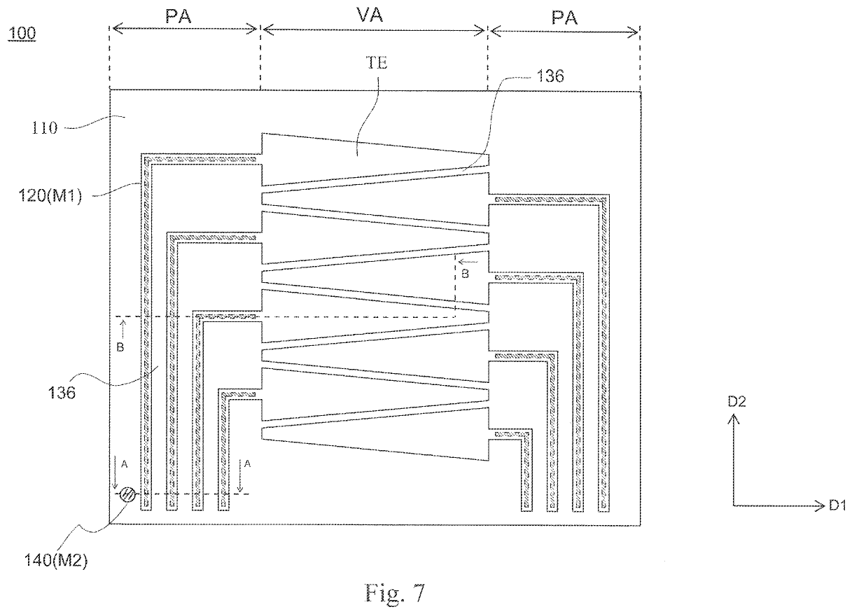

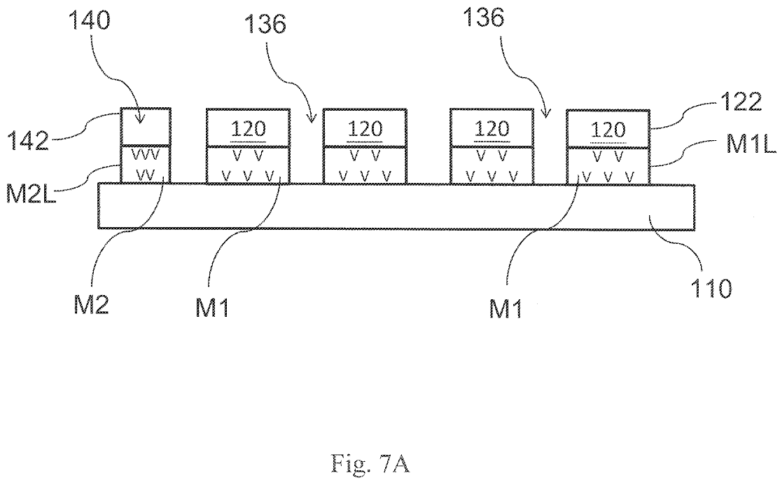

Please refer to FIG. 7, which shows the touch panel 100 completed by the embodiment of the present disclosure (the patterned layer PL has been removed). FIG. 7A and FIG. 7B are the A-A and B-B cross-sections in FIG. 7, respectively. The A-A cross-section can be seen in the peripheral area PA, and the B-B cross-section can be seen in the peripheral area PA and visual area VA. As shown in FIG. 7A and FIG. 7B, the metal nanowires layer NWL and the metal layer ML, which are located in the peripheral area PA, can form a void (i.e., a non-conductive region 136) after the etching step (such as the aforementioned one-time etching solution is used). That is, an etching layer formed from the metal nanowires layer NWL after the patterning step and a peripheral wire 120 formed from the metal layer ML are formed in the peripheral area PA. Because the etching layer is located between the peripheral wire 120 and the substrate 110, the etching layer can be referred to as a first interlayer M1. In other words, there is the first interlayer M1 that is patterned under the peripheral wire 120, and the non-conductive region 136 is between adjacent peripheral wires 120. Furthermore, a side 122 of the peripheral wire 120 and a side M1L of the first interlayer M1 are a common etching surface and are aligned with each other. That is to say, the sidewalls of the patterned layer PL are used as a reference in the patterning step, and the side 122 of the peripheral wire 120 and the side M1L of the first interlayer M1 are formed, in which the side 122 is aligned with the side M1L, according to the sidewalls of the patterned layer PL in the same etching step by using the aforementioned one-time etching solution. Because the structural layer in the peripheral area PA is patterned in the same step, the traditional bit alignment step can be omitted, thereby reducing or avoiding the need for setting alignment bit error area in the manufacturing process. Therefore, the width of the peripheral area PA is reduced, thereby satisfying the narrow bezel requirement of touch panels/touch displays.

In another embodiment, the etching layer formed from the metal nanowires layer NWL, and the peripheral wire 120 and the mark 140, which are formed from the metal layer ML, may be in the peripheral area PA. The etching layer may include the first interlayer M1 and the second interlayer M2, in which the first interlayer M1 is disposed between the peripheral wire 120 and the substrate 110, the second interlayer M2 is disposed between the mark 140 and the substrate 110, and the side 142 of the mark 140 and the side M2L of the second interlayer M2 are a common etching surface and are aligned with each other.

As shown in FIG. 7B, in the visual area VA, the metal nanowires layer NWL also uses the patterned layer PL as an etching mask, and the touch sensing electrode TE is formed in the aforementioned patterning step. In this embodiment, the metal nanowires layer NWL is patterned to form a gap to form the non-conductive region 136 between adjacent touch sensing electrodes TE. Furthermore, the touch sensing electrode TE can be electrically connected to the peripheral wire 120 through the metal nanowires layer NWL extending to the peripheral area PA.

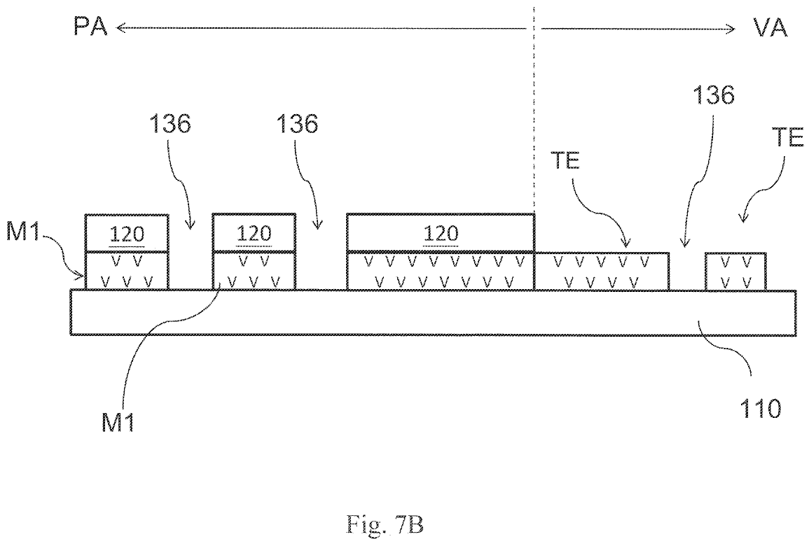

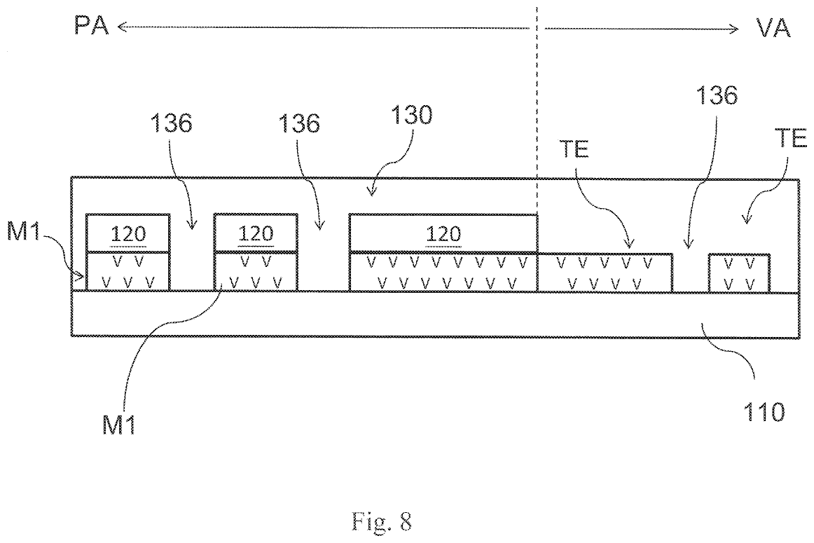

In another embodiment, the aforementioned touch panel 100 may include a film layer 130 or a protective layer. For example, FIG. 8 is a schematic view of the film layer 130 formed on the embodiment shown in FIG. 7B. In one embodiment, the film layer 130 comprehensively covers the touch panel 100. For example, the film layer 130 can be disposed in the visual area VA and the peripheral area PA to cover the touch sensing electrode TE, the peripheral wire 120, and/or the mark 140. As shown in the drawing, in the peripheral area PA, the film layer 130 covers the first peripheral wire 120 and fills into the non-conductive region 136 between the adjacent peripheral wires 120. That is, the non-conductive region 136 between the adjacent peripheral wires 120 has a filling layer made of the same material as the film layer 130. In addition, in terms of a single set of the peripheral wire 120 and the first interlayer M1, the film layer 130 surrounds the single set of the peripheral wire 120 and the first interlayer M1. Similarly, in terms of a single set of the mark 140 and the second interlayer M2, the film layer 130 surrounds the single set of the mark 140 and second interlayer M2.

In the visual area VA, the film layer 130 covers the touch sensing electrode TE and fills into in the non-conductive region 136 between the adjacent touch sensing electrodes TE. That is, the non-conductive region 136 between the adjacent touch sensing electrodes TE has a filling layer made of the same material as the film layer 130 to isolate the adjacent touch sensing electrodes TE.

In some embodiments of the present disclosure, the material of the film layer 130 may be non-conductive resins or other organic materials. For example, the film layer 130 may be polyethylene (PE), polypropylene (PP), or polyvinyl butyral (PVB), polycarbonate (PC), acrylonitrile butadiene styrene (ABS), poly(3,4-ethylenedioxythiophene) (PEDOT), poly(styrene sulfonic acid) (PSS), ceramic materials, etc. In an embodiment of the present disclosure, the film layer 130 may be the following polymer, but the film layer 130 is not limited thereto: polyacrylic resins, such as polymethacrylate (for example, poly(methyl methacrylate)), polyacrylate, and polyacrylonitrile; polyvinyl alcohol; polyester (for example, polyethylene terephthalate (PET), polyester naphthalate, and polycarbonate); polymers with high aromaticity, such as phenolic resin or cresol-formaldehyde, polystyrene, polyvinyl toluene, polyvinyl xylene, polyimide, polyamide, polyamideimide, polyetherimide, polysulfide, polysulfone, polypheylene ether, and polyphenyl ether; polyurethane (PU); epoxy resin; polyolefin (such as polypropylene, polymethylpentene, and cycloolefin); cellulose; polysiloxane and other silicon-containing polymers (such as polysilsesquioxane and polysiloxane); polyvinyl chloride (PVC); polyacetate; polynorbornene; synthetic rubbers (for example, ethylene-propylene rubber (EPR), styrene-butadiene rubber (SBR), ethylene-propylene-diene monomer (EPDM); fluoropolymers (for example, polyvinylidene fluoride, polytetrafluoroethylene (TFE), or hexafluoropropene); copolymers of fluoro-olefin and hydrocarbon olefin, etc. In other embodiments, an inorganic material such as silicon oxide, mullite, alumina, SiC, carbon fiber, MgO—Al₂O₃—SiO₂, Al₂O₃—SiO₂, or MgO—Al₂O₃—SiO₂—Li₂O, etc. can be used. In some embodiments of the present disclosure, the film layer 130 is formed of insulating materials. In some embodiments of the present disclosure, the film layer 130 may be formed by spin coating, spray coating, printing, or the like. In some embodiments, the thickness of the film layer 130 is about 20 nm to 10 μm, or 50 nm to 200 nm, or 30 to 100 nm. For example, the thickness of the film layer 130 may be about 90 nm or 100 nm.

In addition, similar to the foregoing description, the film layer 130 can form a composite structure with the metal nanowires (such as the touch sensing electrode TE) to have some specific chemical, mechanical, and optical properties. For example, the film layer 130 can form a composite structure to improve adhesion of the metal nanowires and the substrate 110 or to have better mechanical strength. Therefore, the film layer 130 can also be referred to as a matrix. It is worth noting that the drawings in the present description illustrate the film layer 130 and the touch sensing electrode TE as different layer structures; however, the polymer used to make the film layer 130 can penetrate between the metal nanowires to form a filler before being cured or in a pre-cured state. After the polymer is cured, the metal nanowires will be embedded into the film layer 130. That is, the present disclosure does not specifically limit the structure between the film layer 130 and the metal nanowires layer NWL (for example, the touch sensing electrode TE). It should be noted that the film layer 130 or the protective layer can be applied to the embodiment of the present disclosure and is not limited to the embodiment shown in FIG. 7B.

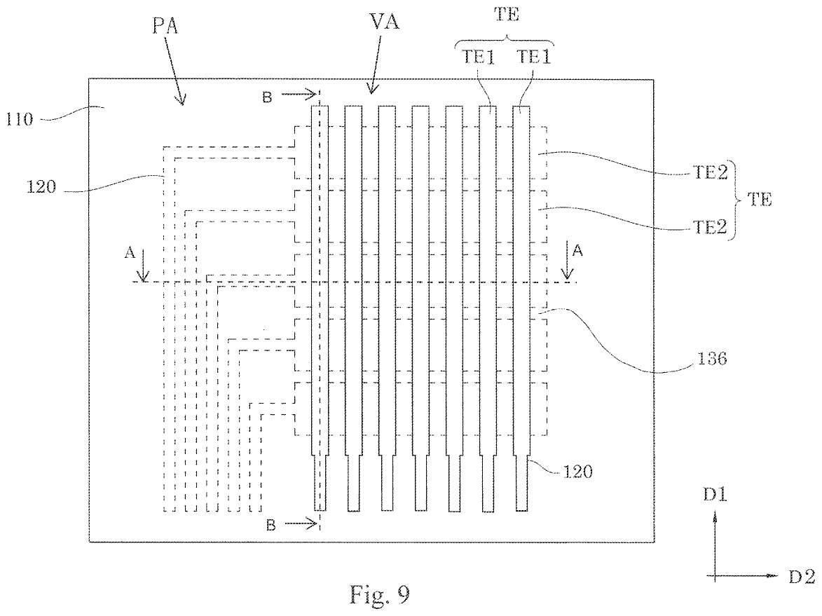

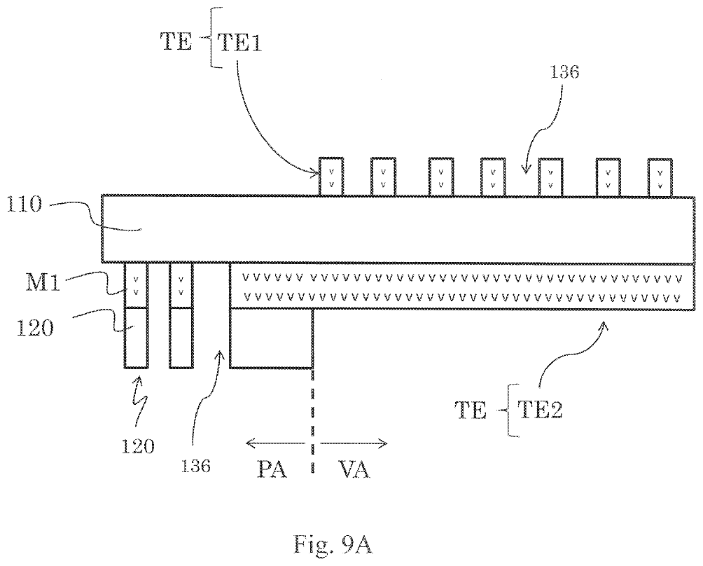

FIG. 9 shows the double-sided touch panel manufactured in the embodiment of the present disclosure. The double-sided touch panel can be manufactured in the following method. Firstly, a substrate 110 is provided, on which there is a predefined peripheral area PA and a predefined visual area VA. Next, a metal nanowires layer NWL is formed on the first surface and second surfaces of the substrate 110 in the peripheral area PA and the visual area VA, respectively, in which the second surface is opposite to the first surface, such as the top surface and the lower surface; then a metal layer ML is formed, and the metal layer ML is located in the peripheral area PA; then patterned layers PL are formed on the metal nanowires layer NWL and the metal layer ML on the first and second surfaces, respectively; then the first and second surfaces are patterned according to the patterned layers PL to form a first touch sensing electrode TE1, a second touch sensing electrode TE2, and a peripheral wire 120, and the peripheral wire 120 covers the first interlayer M1. Embodiments of the present disclosure may also include removing the patterned layer PL. For the simplicity of the drawing, FIG. 9 does not show the first interlayer M1.

The specific implementation of this step can refer to the foregoing description. For example, the etching solution disclosed in the present disclosure can simultaneously etch into different material layers corresponding to different circuits in different areas, such as metal/nanosilver in peripheral area PA and nanosilver in the visual area VA. The obtained circuits have good linearity and the etching solution has good side etching amount (CD bias) control, and no residual material remains in the non-conductive region 136. In addition, this embodiment can directly perform the double-sided etching process, which is beneficial to simplify the process and improve the yield.

Please refer to FIG. 9 and FIG. 9A, the first touch sensing electrode TE1 is formed on one side of the substrate 110 (such as the upper surface), and the second touch sensing electrode TE2 is formed on the other side of the substrate 110 (the lower surface), so that the first touch sensing electrode TE1 and the second touch sensing electrode TE2 are electrically insulated from each other. The peripheral wire 120 electrically connected to the first touch sensing electrode TE1 covers the first interlayer M1. Similarly, the peripheral wire 120 connected to the second touch sensing electrode TE2 correspondingly covers the first interlayer M1. The first touch sensing electrodes TE1 are multiple elongated electrodes arranged along the first direction D1, and the second touch sensing electrodes TE2 are multiple elongated electrodes arranged along the second direction D2. As shown in the drawing, the elongated touch sensing electrode TE1 and the elongated touch sensing electrode TE2 extend in different directions and are staggered. The first touch sensing electrodes TE1 and the second touch sensing electrodes TE2 can be used to transmit control signals and receive touch sensing signals, respectively. Therefore, the touching position can be obtained by detecting the signal change (for example, the capacitance change) between the first touch sensing electrodes TE1 and the second touch sensing electrodes TE2. With this arrangement, users can perform touch sensing at each point on the substrate 110. The touch panel 100 of this embodiment may also include film layers 130, which comprehensively cover the touch panel 100. That is to say, the film layers 130 are provided on both the upper and lower sides of the substrate 110 and cover the first touch sensing electrode TE1, the second touch sensing electrode TE2, and the peripheral wire 120. The film layers 130 also cover and fill into the non-conductive regions 136 on both sides of the substrate 110.

Similar to the foregoing embodiment, any sides (such as the upper side and the lower side) of the substrate 110 may further include the mark 140 and the second interlayer M2.

FIG. 10 is a schematic top view of a touch panel 100 according to some embodiments of the present disclosure. This embodiment is similar to the previous embodiments. The main difference is that, in this embodiment, the touch panel 100 also includes a shielding wire 160 disposed in the peripheral area PA. The shielding wire 160 mainly surrounds the touch sensing electrode TE and the peripheral wire 120, and the shielding wire 160 extends to the bonding area BA and is electrically connected to the ground terminal on the flexible printed circuit board 170. Therefore, the shielding wire 160 can shield or eliminate signal interference or provide electrostatic discharge (ESD) protection, especially the small electric current changes caused by human hands touching the connecting wires around the touch device.

According to the aforementioned manufacturing method, the shielding wire 160 and the peripheral wire 120 can be made of the same metal layer ML (i.e., both are the same metal material, such as the aforementioned electroless copper layer), and the metal nanowires layer NWL (also referred to as the third covering layer) is stacked on them. The shielding wire 160 is made after the etching step according to the pattern of the patterned layer PL. It can also be understood that the shielding wire 160 is a composite structure layer including the metal nanowires layer NWL (or a composite layer with film layer) and the metal layer ML. For details, please refer to FIG. 2A and the description of the embodiment shown in FIG. 2B. In addition, in another embodiment, the shielding wire 160 and the peripheral wire 120 can be made of the same layer of metal layer ML (i.e., both are made of the same metal material, such as the aforementioned electroless copper layer). The shielding wire 160 is made after the etching step according to the pattern of patterned layer PL and then the patterned layer PL is removed. Therefore, it can also be understood that the shielding wire 160 is a composite structure layer including the metal nanowires layer NWL (or the third interlayer) and the metal layer ML. It can also be understood that the shielding wire 160 is a composite structure layer including the metal nanowires layer NWL (or the composite layer with the film layer) and the metal layer ML. For details, please refer to the description of the embodiments shown in FIG. 7A and FIG. 7B.

FIG. 11 shows another embodiment of the single-sided touch panel 100 of the present disclosure, which is a single-sided bridge touch panel. The difference between this embodiment and the aforementioned embodiment is at least that the touch sensing electrode TE formed by the transparent conductive layer (i.e., the metal nanowires layer NWL) formed on the substrate 110 after the aforementioned patterning step may include: the first touch sensing electrode TE1 arranged along the first direction D1, the second touch sensing electrode TE2 arranged along the second direction D2, and a connecting electrode CE electrically connected to two adjacent first touch sensing electrodes TE1. In addition, an insulating block 164 may be disposed on the connecting electrode CE, for example, silicon dioxide is used to form the insulating block 164; and a bridging wire 162 is further disposed on the insulating block 164, for example, the bridging wire 162 is formed of copper/ITO/metal nanowires and the like, and the bridging wire 162 is connected to two adjacent second touch sensing electrodes TE2 in the second direction D2. The insulating block 164 is located between the connecting electrode CE and the bridging wire 162 to electrically isolate the connecting electrode CE and the bridging wire 162, so that the touch electrodes in the first direction D1 and the second direction D2 are electrically isolated from each other. For the specific method, please refer to the previous description, and it will not repeat herein. Similar to the aforementioned embodiment, the peripheral wire 120 is made of the metal layer ML (for example, the aforementioned electroless copper plating layer), on which the metal nanowires layer NWL is stacked, both of which are formed using the aforementioned etching solution. Similarly, the first touch sensing electrode TE1 and the second touch sensing electrode TE2 are formed by using the aforementioned etching solution, and the peripheral wires 120 are respectively connected to the first touch sensing electrode TE1 and the second touch sensing electrode TE2.

The touch panel of the embodiment of the present disclosure can be assembled with other electronic devices, such as a display with the touch function. For example, the substrate 110 can be attached to a display element, such as a liquid crystal display element or an organic light emitting diode (OLED) display element. The optical cement or other similar adhesives can be used for bonding between them; and the touch sensing electrode TE can also be bonded with the outer cover layer (such as a protective glass) by using the optical cement. The touch panel of the embodiment of the present disclosure can be applied to electronic devices such as portable phones, tablet computers, and notebook computers.

In some embodiments, the touch panel 100 described herein can be manufactured through a roll-to-roll process. The roll-to-roll coating process uses conventional equipment and can be fully automated, which can significantly reduce the cost of manufacturing touch panels. The specific process of the roll-to-roll coating is as follows. Firstly, a flexible substrate 110 is selected, and a tape-shaped substrate 110 is installed between the two rollers. A motor is used to drive the rollers so that the substrate 110 can perform a continuous manufacturing process along the moving path between the two rollers. For example, a plating tank is used to deposit the metal layer ML. A storage tank, a spray device, a brushing device, and the like are used to deposit an ink including metal nanowires on the surface of the substrate 110, and a curing step is applied to form a metal nanowires layer NWL. A patterned layer PL with patterns is formed (for example, the aforementioned flexographic printing method is used) on the metal layer ML and/or the metal nanowires layer NWL. An etching tank or spraying etching solution is used for the patterning step and other steps. Subsequently, the completed touch panel 100 is rolled out by the rollers at the rear end of the production line to form a touch sensor tape.

The touch sensor tape of this embodiment may also include the film layer 130, which comprehensively covers the uncut touch panel 100 on the touch sensor tape. That is, the film layer 130 can cover multiple uncut touch panels 100 on the touch sensor tape, and then multiple uncut touch panels 100 are cut and separated into individual touch panel 100.

In some embodiments of the present disclosure, the substrate 110 is preferably a transparent substrate. Specifically, the substrate 110 can be a rigid transparent substrate or a flexible transparent substrate that includes transparent materials such as selected from glass and polymethylmethacrylate (PMMA), polyvinyl chloride (PVC), polypropylene (PP), polyethylene terephthalate (PET), polyethylene naphthalate (PEN), polycarbonate (PC), polystyrene (PS), cycloolef in polymers (COP), cycloolef in copolymer (COC), etc.

The roll-to-roll production line can adjust the sequence of multiple coating steps along the moving path of the substrate as required or can incorporate any number of additional stages as required. For example, in order to achieve an appropriate post-processing, pressure rollers or plasma equipment can be installed in the production line.

In some embodiments, the formed metal nanowires may be further treated to post-processing to increase conductivity of the formed metal nanowires. The post-processing may include process steps such as heating, plasma, corona discharge, UV ozone, pressure, or combinations of the above processes. For example, after the step of curing to form the metal nanowires layer NWL, roller(s) can be used to apply pressure thereon. In one embodiment, a pressure of 50 to 3400 psi can be applied onto the metal nanowires layer NWL through one or more rollers, preferably the pressure is between 100 and 1000 psi, 200 and 800 psi, or 300 and 500 psi. The step of applying the pressure described above is preferably implemented before the step of coating the film layer 130. In some embodiments, heating and pressure post-processing can be performed at the same time. In detail, the pressure applies to the formed metal nanowires through one or more rollers as described above, and the formed metal nanowires are heated at the same time. For example, the pressure applied by the roller is 10 to 500 psi, preferably 40 to 100 psi, while heating the roller to between about 70° C. and 200° C., preferably between about 100° C. and 175° C., thereby increasing the conductivity of the metal nanowires. In some embodiments, the metal nanowires can preferably be exposed to a reducing agent for the post-processing. For example, the metal nanowires formed from silver nanowires can preferably be exposed to a silver reducing agent for the post-processing. The silver reducing agent includes borohydrides, such as sodium borohydride; boron nitrogen compounds, such as dimethylamino borane (DMAB); or gaseous reducing agents, such as hydrogen (H₂). The exposure time is about 10 seconds to about 30 minutes, preferably about 1 minute to about 10 minutes.

The other details of this embodiment are similar to the foregoing embodiment as disclosed and will not be repeated herein.

The structures of different embodiments of the present disclosure can be mutually cited and are not limited to the foregoing specific embodiments.

In some embodiments of the present disclosure, the metal nanowires layer NWL and/or the metal layer ML are etched through one-time etching step by the etching solution; therefore, the error space reserved during the alignment process can be avoided, so the width of the peripheral area can be effectively reduced.

In some embodiments of the present disclosure, the two-layer structure (for example, the upper layer is the metal nanowires layer NWL and the lower layer is the metal layer ML; or the upper layer is the metal layer ML and the lower layer is the metal nanowires layer NWL) can be etched through the one-time etching step to form the peripheral wire and/or the mark in the peripheral area. Therefore, the error space reserved in the alignment process can be avoided, and the width of the peripheral area can be effectively reduced.

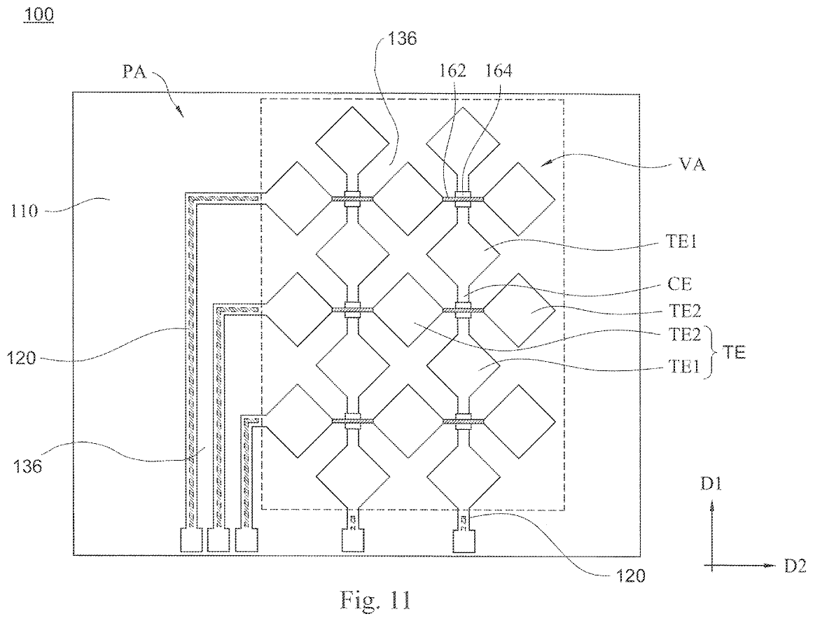

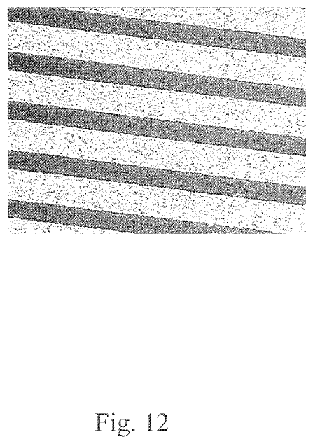

In some embodiments of the present disclosure, the copper layer and the silver nanowire layer are etched by the aforementioned etching solution. As shown in FIG. 12, the CD bias is 3 prn after etching 60 seconds.

While the disclosure has been described by way of example(s) and in terms of the various embodiment(s), it is to be understood that the disclosure is not limited thereto. Any person skilled in the art can make various arrangements and modifications without departing from the spirit and scope of the present disclosure. Therefore, the scope of protection shall be determined by the scope of the claims of the attached patent application.

What is claimed is:

1. A manufacturing method of a touch panel, comprising:
providing a substrate, wherein the substrate has a visual area and a peripheral area;
disposing a metal layer and a metal nanowires layer, wherein a first portion of the metal nanowires layer is located in the visual area, and a second portion of the metal nanowires layer and the metal layer are located in the peripheral area; and
performing a patterning step, wherein the patterning step comprises forming the metal layer into multiple peripheral wires and simultaneously forming the second portion of the metal nanowires layer into multiple etching layers by using an etching solution for etching the metal layer and the metal nanowire layer, wherein the etching solution comprises 0.2-40 wt % of hydrogen peroxide, 0.1-20 wt % of an acid, 0.1-10 wt % of a metal corrosion inhibitor, 0.1-10 wt % of a stabilizer, and a balance of a solvent.

2. The manufacturing method of claim 1, wherein the patterning step further comprises forming the first portion of the metal nanowires layer into a touch sensing electrode by using the etching solution, wherein the touch sensing electrode is disposed on the substrate in the visual area, and the touch sensing electrode is electrically connected to the multiple peripheral wires.

3. The manufacturing method of claim 1, wherein the metal corrosion inhibitor comprises a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

4. The manufacturing method of claim 1, wherein the stabilizer comprises ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

5. The manufacturing method of claim 1, wherein the disposing the metal layer and the metal nanowires layer comprises:
disposing the metal layer in the peripheral area; and
subsequently disposing the metal nanowires layer in the visual area and the peripheral area, wherein the first portion is located in the visual area and formed on the substrate, and the second portion is located in the peripheral area and formed on the metal layer.

6. The manufacturing method of claim 5, wherein the disposing the metal layer in the peripheral area comprises:
forming the metal layer in the peripheral area and the visual area; and
removing the metal layer located in the visual area.

7. The manufacturing method of claim 5, wherein the etching solution comprises 1.0-10.0 wt % of hydrogen peroxide, 1.0-5.0 wt % of the acid, 2.0-7.0 wt % of the metal corrosion inhibitor, 3.0-8.0 wt % of the stabilizer, and a balance of the solvent.

8. The manufacturing method of claim 1, wherein the patterning step further comprises forming the metal layer into multiple marks by using the etching solution, wherein the multiple etching layers comprise multiple first coverings and multiple second coverings, each of the multiple first coverings is correspondingly disposed on the multiple peripheral wires, and each of the multiple second coverings is correspondingly disposed on the multiple marks.

9. The manufacturing method of claim 1, wherein the disposing the metal layer and the metal nanowires layer comprises:
disposing the metal nanowires layer in the visual area and the peripheral area; and
subsequently disposing the metal layer in the peripheral area, wherein the metal layer is located on the second portion.

10. The manufacturing method of claim 9, wherein a composition of the etching solution comprises 1.0-5.0 wt % of hydrogen peroxide, 0.1-0.6 wt % of the acid, 2.0-7.0 wt % of the metal corrosion inhibitor, 3.0-8.0 wt % of the stabilizer, and a balance of the solvent.

11. The manufacturing method of claim 9, wherein the patterning step further comprises forming the metal layer into multiple marks by using the etching solution, wherein the multiple etching layers comprises multiple first interlayers and multiple second interlayers, each of the multiple first interlayers is correspondingly disposed between the multiple peripheral wires and the substrate, and each of the multiple second interlayers is correspondingly disposed between the multiple marks and the substrate.

12. The manufacturing method of claim 1, further comprising disposing a film layer.

13. The manufacturing method of claim 1, wherein the manufacturing method is performed on one side or both sides of the substrate.

14. A touch panel made by the manufacturing method of the touch panel of claim 1.

15. An etching solution used for performing a patterning step, comprising: 0.2-40 wt % of hydrogen peroxide, 0.1-20 wt % of an acid, 0.1-10 wt % of a metal corrosion inhibitor, 0.1-10 wt % of a stabilizer, and a balance of a solvent.

16. The etching solution of claim 15, wherein the acid comprises an organic acid, an inorganic acid, or combinations thereof.

17. The etching solution of claim 16, wherein the organic acid comprises a carboxylic acid, a dicarboxylic acid, a tricarboxylic acid, an alkyl carboxylic acid, an acetic acid, an oxalic acid, a benzenehexacarboxylic acid, a formic acid, a chloroacetic acid, a benzoic acid, a trifluoroacetic acid, a propionic acid, a butyric acid, or combinations thereof.

18. The etching solution of claim 16, wherein the inorganic acid comprises a phosphoric acid, a nitric acid, a hydrochloric acid, or combinations thereof.

19. The etching solution of claim 15, wherein the metal corrosion inhibitor comprises a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

20. The etching solution of claim 15, wherein the stabilizer comprises ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

21. An etching solution used for performing a patterning step, comprising: 0.01-50 wt % of hydrogen peroxide, 0.1-10 wt % of a metal corrosion inhibitor, 0.1-10 wt % of a stabilizer, and a balance of a solvent.

22. The etching solution of claim 21, wherein the metal corrosion inhibitor comprises a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

23. The etching solution of claim 21, wherein the stabilizer comprises ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

24. A manufacturing method of a touch panel, comprising:
providing a substrate, wherein the substrate has a visual area and a peripheral area;
disposing a metal layer and a metal nanowires layer, wherein a first portion of the metal nanowires layer is located in visual area, and a second portion of the metal nanowires layer and the metal layer are located in the peripheral area; and
performing a patterning step, wherein the patterning step comprises etching the metal nanowires layer by using an etching solution and etching the metal layer by using a second etching solution, to form the metal layer into multiple peripheral wires and simultaneously form the second portion of the metal nanowires layer into multiple etching layers, wherein the etching solution comprises 0.01-50 wt % of hydrogen peroxide, 0.1-10 wt % of a metal corrosion inhibitor, 0.1-10 wt % of a stabilizer, and a balance of a solvent.

25. The manufacturing method of claim 24, wherein the patterning step further comprises forming the first portion of the metal nanowires layer into a touch sensing electrode by using the etching solution, wherein the touch sensing electrode is disposed on the substrate in the visual area, and the touch sensing electrode is electrically connected to the multiple peripheral wires.

26. The manufacturing method of claim 24, wherein the metal corrosion inhibitor comprises a nitrogen-containing organic compound, a sulfur-containing organic compound, a hydroxyl-containing organic compound, an organic compound having surface activity, mercaptobenzothiazole, benzotriazole, methylbenzotriazole, or combinations thereof.

27. The manufacturing method of claim 24, wherein the stabilizer comprises ethylenediaminetetraacetic acid, diethylenetriaminepentaacetic acid, hydroxyethylethylenediaminetriacetic acid, diethylaminopentaacetic acid, N-(2-hydroxyethyl)ethylenediaminetriacetic acid, polyacrylamide, or combinations thereof.

28. The manufacturing method of claim 24, wherein the disposing the metal layer and the metal nanowires layer comprises:
disposing the metal layer in the peripheral area; and
subsequently disposing the metal nanowires layer in the visual area and the peripheral area, wherein the first portion is located in the visual area and formed on the substrate, and the second portion is located in the peripheral area and formed on the metal layer.

29. The manufacturing method of claim 28, wherein the disposing the metal layer in the peripheral area comprises:
forming the metal layer in the peripheral area and the visual area; and
removing the metal layer located in the visual area.

30. The manufacturing method of claim 24, wherein the patterning step further comprises forming the metal layer into multiple marks by using the etching solution, wherein the multiple etching layers comprises multiple first coverings and multiple second coverings, each of the multiple first coverings is correspondingly disposed on the multiple peripheral wires, and each of the multiple second coverings is correspondingly disposed on the multiple marks.

31. The manufacturing method of claim 24, wherein the disposing the metal layer and the metal nanowires layer comprises:
disposing the metal nanowires layer in the visual area and the peripheral area; and
subsequently disposing the metal layer in the peripheral area, wherein the metal layer is located on the second portion.

32. The manufacturing method of claim 31, wherein the disposing the metal layer in the peripheral area comprises:
forming the metal layer in the peripheral area and the visual area; and
removing the metal layer located in the visual area.

33. The manufacturing method of claim 31, wherein the patterning step further comprises forming the metal layer into multiple marks by using the etching solution, wherein the multiple etching layers comprises multiple first interlayers and multiple second interlayers, each of the multiple first interlayers is correspondingly disposed between the multiple peripheral wires and the substrate, and each of the multiple second interlayers is correspondingly disposed between the multiple marks and the substrate.

34. The manufacturing method of claim 24, further comprising disposing a film layer.

35. The manufacturing method of claim 24, wherein the manufacturing method is performed on one side or both sides of the substrate.

36. A touch panel made by the manufacturing method of the touch panel of claim 24.
